(19) United States
(12) Patent Application Publication
(10) Pub. No.: US 2007/0264448 A1
(43) Pub. Date: Nov. 15, 2007

(54) Thermoplastic resin film and method of manufacturing the same

(75) Inventor: Akihide Fujita, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/797,277

(22) Filed: May 2, 2007

(30) Foreign Application Priority Data
May 10, 2006 (JP) 2006-131950

(51) Int. Cl. C09K 19/52; B29C 47/88; B29C 67/00; B29C 31/00

(52) U.S. Cl. 428/1.31; 264/211.12; 264/175

(57) ABSTRACT

The present invention provides a method of manufacturing a thermoplastic resin film comprising the steps of: extruding a molten thermoplastic resin from a die in a form of sheet; cooling and solidifying the thermoplastic resin sheet by sandwiching the sheet between a pressurizing/cooling roller and a press roller; and further cooling and solidifying the thermoplastic resin sheet while transferring the thermoplastic resin sheet by a plurality of cooling rollers, wherein the temperature of each of the cooling rollers is set at within a range of ±3° C. relative to sheet temperature of the thermoplastic resin sheet in contact with the cooling roller; at the same time, the sheet temperature of the thermoplastic resin sheet when removed from the cooling roller arranged most downstream of the cooling rollers is set to be equal to or less than a glass transition temperature Tg(° C.) of the thermoplastic resin −15° C.

### BACKGROUND OF THE INVENTION

1. Field of the Invention

The present invention relates to a thermoplastic resin film and a method of manufacturing the same, and more particularly, to a thermoplastic resin film having a quality suitable for a liquid crystal display device and a method of manufacturing the same.

2. Description of the Related Art

In the art, a thermoplastic resin film is stretched to produce in-plane retardation (Re) and retardation in the thickness direction (Rth). Such a stretched film is used as a phase-difference film for a liquid crystal display device to enlarge the viewing angle of the device.

To stretch such a thermoplastic resin film, there are a longitudinal stretching method for stretching a film in the longitudinal (machine) direction, a transverse stretching method for stretching a film in the transverse (width) direction, and a simultaneous stretching method for stretching a film longitudinally and transversely at the same time. Of these methods, the longitudinal stretching has been frequently used from the past because the stretching equipment is compact. In the longitudinal stretching, a film, which is heated to not less than a glass transition temperature (Tg), is placed between not less than two pairs of nip rollers, and the film is stretched in the longitudinal direction by setting the transfer speed of the nip roller on the output port side to be higher than that on the input port side.

Japanese Patent Application Laid-Open No. 2002-311240 describes a method of stretching a cellulose ester longitudinally. In this patent document, a film is stretched longitudinally in the direction opposite to the flow-casting film-forming direction. In this manner, variance in angle of a slow-phase axis improved. On the other hand, Japanese Patent Application Laid-Open No. 2003-315551 describes a method of stretching a film by arranging nip rollers, which are arranged in a short span having an aspect ratio (L/W) of 0.3 to 2 (both inclusive), in a stretching zone. According to the patent document, the retardation (Rth) in the thickness direction can be improved. The aspect ratio used herein is a quotient obtained by dividing the distance (L) between the stretching nip rollers by the width (W) of the thermoplastic resin film to be stretched.

### SUMMARY OF THE INVENTION

When the thermoplastic resin film before stretched, that is, unstretched thermoplastic resin film, is formed by cooling and solidifying a molten resin on a cooling roller having an inappropriate temperature, the resultant film is often damaged by streaks and the retardation of the film increases.

The present invention was contrived in view of these circumstances. An object to the present invention is to provide a thermoplastic resin film capable of preventing damage such as streaks and suppressing retardation, and thereby obtaining an optical film uniform in optical properties, and a method of manufacturing the same.

According to a first aspect of the invention, to attain the aforementioned object, there is provided a method of manufacturing a thermoplastic resin film comprising extruding a molten thermoplastic resin from a die in the form of sheet, cooling and solidifying the thermoplastic resin sheet by sandwiching the sheet between a pressurizing/cooling roller and a press roller having a surface roughness Ra of 100 nm or less in terms of an arithmetic average height, and further cooling and solidifying the thermoplastic resin sheet while transferring the thermoplastic resin sheet by a plurality of cooling rollers, in which the temperature of each of the cooling rollers is set at within the range of ±3° C. relative to sheet temperature of the thermoplastic resin sheet in contact with the cooling roller; at the same time, the sheet temperature of the thermoplastic resin sheet when removed from the cooling roller arranged most downstream of the cooling rollers is set to be equal to or less than a glass transition temperature Tg(° C.) of the thermoplastic resin −15° C.

The present inventors investigated on causes of generation of streaks and retardation of the film in the method of manufacturing a film by melt film formation, which is a method of forming a film by extruding a molten thermoplastic resin from a die in the form of sheet and cooling and solidifying the sheet while transferring the sheet by a plurality of cooling rollers. As a result, they found that rapid cooling of the film by cooling rollers immediately after formation thereof is a cause. To explain more specifically, when the film is cooled by a plurality of cooling rollers, the temperatures of the rollers are set in order to cool and solidify the film. Therefore, when the film is brought into contact with the cooling rollers, a temperature difference is produced. Due to the temperature difference, the film is rapidly shrunken on the cooling rollers. As a result, streaks and retardation of the film are generated. In the circumstances, the present inventors contrived that cooling is not performed on the cooling rollers but performed in no contact with the cooling rollers. In other words, the film is cooled in the space between the cooling rollers while transferring the film. In this manner, they overcome the cause. The cause can be overcome preferably by removing the difference between the film temperature, which is the temperature of the film in contact with a cooling roller, and the temperature of the cooling roller in contact with the film. However, if the temperature difference between them falls within the range of ±3° C., the cause can be overcome without any problem. Furthermore, the temperature of the film most downstream of a plurality of cooling rollers is set at equal to or less than Tg(° C.) of the resin −15° C. In this manner, the film can be cooled and solidified in the spaces between a plurality of cooling rollers while transferring the film from roller to roller.

Furthermore, the manufactured film has sometimes uneven thickness and distribution of retardation (Re, Rth). The present inventors investigated intensively on causes of them. They found that the problems can be overcome by forming a film by a touch roll method. In the touch roll method, a resin extruded from a die is cooled while sandwiching it by the pressurizing/cooling roller and a press roller. In this way, dimensional accuracy in thickness can be improved. They found that the distribution of retardation (Re, Rth) is induced by unevenness of the film in thickness before stretched. The film manufactured by the touch roll method has a good dimensional accuracy in thickness. Since such a film can be stretched uniformly, there are virtually no portions stretched non-uniformly. In this way, they found that the distribution of retardation can be suppressed.

According to the invention of the first aspect, the temperature of each of the cooling rollers is set so as to fall within the temperature of the sheet in contact with the cooling roller ±3° C.; at the same time, the temperature of the sheet when it removes from the cooling roller which is arranged most downstream of a plurality of rollers, is set at equal to or less than the glass transition temperature Tg(° C.) of the thermoplastic resin −15° C. Since the sheet is not cooled by the cooling rollers but cooled in the space between the cooling rollers in this manner, it is possible to suppress the sheet from rapidly shrinking on the cooling roller, with the result that generation of streaks and retardation can be suppressed. Furthermore, since the unevenness of the film in thickness and distribution of retardation can be suppressed, a thermoplastic resin film suitable for optical use having a good dimensional accuracy in thickness and uniform optical characteristics in the width/longitudinal direction can be obtained.

According to a second aspect of the invention, there is provided a method of manufacturing a thermoplastic resin film according to the first aspect, characterized in that, in the pressurizing/cooling roller and the cooling rollers, the ratio in circumference speed of rollers arranged adjacent with each other satisfies Equation (1) and the sheet length between adjacent rollers satisfies Equation (2),

0.98×(1−cₙ/100)<[(roller circumference speed ratio)=ωₙ₊₁ωₙ]<1.02×(1−cₙ/100) (1);

sₙ/rₙ>0.3 (2);

where the diameter of the roller arranged at the n-th position from the upstream side is represented by rₙ (cm), the length of the sheet between the n-th roller and the (n+1)th roller is represented by sₙ (cm), the thermal shrinkage of the sheet between the n-th roller and the (n+1)th roller is represented by cₙ(%), the circumference speed of the n-th roller is represented by ωₙ.

According to the invention of the second aspect, in the pressurizing/cooling roller and the cooling rollers, the ratio of the circumference speed ωₙ₊₁ of the n+1 th roller to the circumference speed ωₙ of the n-th roller (arranged upstream side thereof) is set so as to satisfy Equation (1) above; at the same time, the sheet length between adjacent rollers is set so as to satisfy Equation (2). By virtue of this, the sheet cannot become loose, slip or be stretched on the cooling roller(s). Therefore, it is possible to suppress streaks and generation of retardation.

The invention according to a third aspect is directed to the invention according to one of the first and second aspects, characterized in that at least one of the pressurizing/cooling roller and the press roller is an elastic roller made of a metal.

According to the invention of the third aspect, at least one of the pressurizing/cooling roller and the press roller is an elastic roller made of a metal. Such a roller elastically deforms and comes into surface contact with the other roller via the thermoplastic resin sheet and presses the surface of the thermoplastic resin sheet uniformly by reconstitution force of the roller returning to the original shape. When the resin is cooled while being pressed uniformly flatwise, the film can be formed without residual strain inside the film. In this manner, the generation of retardation can be suppressed during the film formation process.

The invention according to a fourth aspect is directed to the method according to the third aspect, characterized in that the pressurizing/cooling roller and the press roller satisfy any one of Equations (3), (4), and (5) below:

0.0043X²+0.12X+1.1<Y<0.019X²+0.73X+24 (3),

where the difference between the glass transition temperature Tg(° C.) of the thermoplastic resin and the temperature of the elastic roller is represented by X(° C.), and a line speed is represented by Y (m/min);

0.05 mm<Z<7.0 mm (4),

where Z is a wall thickness of an outer cylinder of the elastic roller;

3 kg/cm²<P/Q<50 kg/cm² (5),

where the length of the region at which the pressurizing/cooling roller and the press roller are in contact with each other via the thermoplastic resin sheet, is represented by Q (cm), and a line pressure applied by the pressurizing/cooling roller and the press roller sandwiching the thermoplastic resin sheet is represented by P (kg/cm).

According to the invention of the fourth aspect, when the pressuring/cooling roller and the press roller sandwich a thermoplastic resin, since the wall thickness Z of an outer cylinder of the elastic roller (the pressuring/cooling roller and/or the press roller) is set so as to satisfy 0.05 mm<Z<7.0 mm, the elastic roller is elastically deformed and comes into surface contact with the other roller via the thermoplastic resin sheet; at the same time can press the resin flatwise and uniformly by reconstitution force of the roller returning to the original shape. When the wall thickness Z of the outer cylinder of the elastic roller is not more than 0.05 mm, the reconstitution force is too small to improve the surface roughness. Besides this, the strength of the roller becomes weak. In contrast, when the wall thickness Z is 7.0 mm or more, the elasticity cannot be obtained and residual strain cannot be overcome. Note that as long as the wall thickness Z of the outer cylinder satisfies 0.05 mm<Z<7.0 mm, no problem rises; however, the wall thickness more preferably satisfies 0.2 mm<Z<5.0 mm.

Furthermore, provided that the difference between the glass transition temperature Tg(° C.) of a thermoplastic resin and the temperature of the elastic roller is represented by X(° C.), and a line speed is represented by Y (m/min), X and Y satisfies:

0.0043X²+0.12X+1.1<Y<0.019X²+0.73X+24.

It is therefore possible to overcome residual strain of the film and adhesion of the film onto the elastic roller. To explain more specifically, when a film was observed from various view points while the temperature and line speed Y of the elastic roller are changed, the following facts were found. When the line speed Y is equal to or less than 0.0043X²+0.12X+1.1, the pressurization time is so long that residual strain is produced in the film, generating retardation. In contrast, when the line speed Y is equal to or more than 0.019X²+0.73X+24, the cooling time is so short that the film cannot be cooled gradually. As a result, the film is adhered to the elastic roller. Note that the line speed Y is the one for forming the film and coincides with the speed of the pressurizing/cooling roller.

Furthermore, when the length of the region at which the pressurizing/cooling roller and the press roller are in contact with each other via the thermoplastic resin sheet, is represented by Q (cm) and a line pressure applied by the pressurizing/cooling roller and the press roller sandwiching the thermoplastic resin sheet is represented by P (kg/cm), P and Q satisfy the relationship:

3 kg/cm²<P/Q<50 kg/cm².

By virtue of this, the residual strain of the film can be prevented. When P/Q is 3 kg/cm² or less, the press force for pressurizing the resin flatwise is too low to improve the surface roughness. In contrast, when P/Q is 50 kg/cm or more, the press force is so large that residual strain is produced in the film, generating retardation. Note that the contact length Q is the length of the elastic roller in contact with the resin. The contact length can be measured by, for example, sandwiching a prescale, (which is a sheet generating a color in response to pressure) in combination with a spacer between the pressurizing/cooling roller and the press roller in a stationary state so as to make the thickness equal to that of the resin, and measuring the length of the color-emitting portion of the prescale. Also, the line pressure P can be measured by, for example, the prescale in the same manner. The contact length Q and the line pressure P can be controlled by changing the pressure of the cylinder of the roller.

The invention according to a fifth aspect is directed to the invention according to any one of the first to fourth aspects, characterized in that the plurality of cooling rollers have a surface roughness Ra of 100 nm or less in terms of an arithmetic average height.

According to the invention of the fifth aspect, since the surface roughness Ra of each of the cooling rollers in terms of an arithmetic average height is 100 nm or less, the surface state in roughness of the film can be improved.

The invention according to a sixth aspect is directed to the invention according to any one of the first to fifth aspects, in which a zero shear viscosity of the thermoplastic resin extruded from the die is 2000 Pa·sec or less.

According to the invention of the sixth aspect, the zero shear viscosity of the thermoplastic resin extruded from the die is 2000 Pa·sec or less. By virtue of this, generation of streaks in the film can be also prevented. Note that, when the zero shear viscosity exceeds 2000 Pa·sec, the molten resin widely spreads immediately after extrudion from the die. The molten resin thus spread readily attaches to the tip portion of the die and smears the film in the form of streak. The zero shear viscosity can be obtained by obtaining data of the dependency of the molten resin viscosity upon shear rate by a plate-corn form molten resin viscosity measuring device and extrapolating the melt viscosity at the time of the zero shear rate from the measurement value of the melt viscosity in the region having no viscosity dependency.

The invention according to a seventh aspect is directed to the invention according to any one of the first to sixth aspects, characterized in that a thickness of the film is 20 to 300 μm, in-plane retardation Re is 20 nm or less and retardation Rth in a thickness direction is 20 nm or less.

According to the present invention, a thermoplastic resin film having good dimensional accuracy in thickness, no streaks and small stain, which are all suitable characteristics for an optical film, can be manufactured. Therefore, a thermoplastic resin film having a thickness of the film of 20 to 300 μm, an in-plane retardation Re of 20 nm or less and a retardation Rth in a thickness direction of 20 nm or less can be manufactured.

The invention according to an eighth aspect is directed to a thermoplastic resin film characterized by being manufactured by the method according to any one of the first to seventh aspects.

The invention according to a ninth aspect is directed to the invention according to the eighth aspect, characterized in that the thermoplastic resin is a cellulose acylate resin.

The present invention is particularly effective in manufacturing a cellulose acylate film having good retardation.

The invention according to a tenth aspect is directed to the invention according to the ninth aspect, characterized in that the cellulose acylate resin has a number average molecular weight of 20,000 to 80,000, and provided that degree of substitution with an acetyl group is represented by A and the sum of degrees of substitution with acyl groups having 3 to 7 carbon atoms is represented by B, A and B satisfy:

2.0≦A+B≦3.0,

0≦A≦2.0,

1.2≦B≦2.9.

The cellulose acylate resin satisfying these substitution degrees is characterized by having a low melting point, good stretching ability, and excellent moisture-proof properties. Therefore, a thermoplastic resin film excellent as a functional film used as, for example, a phase contrast film of a liquid crystal display device can be obtained.

The invention according to an eleventh aspect is directed to an optical compensation film for use in a liquid crystal display board characterized by having a substrate formed of the thermoplastic resin film according to any one of eighth to tenth aspects. The invention according to a twelfth aspect is directed to a polarizer employing at least one of the thermoplastic resin film according to any one of eighth to tenth aspects as a protecting film.

Since the thermoplastic resin film according to any one of the eighth to tenth aspects has high optical properties, the film is suitable for an optical compensation film for liquid crystal display board or a polarizer.

According to the present invention, a molten resin is cooled and solidified on cooling rollers while suppressing generation of streaks and retardation. Therefore, it is possible to provide a thermoplastic resin film applicable to a film for optical use requiring uniform optical properties and a method of manufacturing the same.

### BRIEF DESCRIPTION OF THE STRETCHINGS

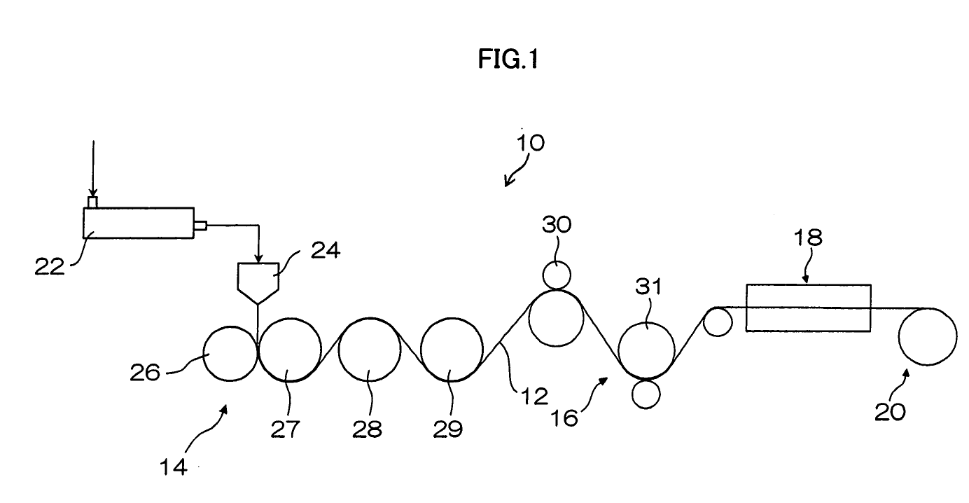

FIG. 1 is a schematic view of a structure of a film-forming apparatus to which the present invention is to be applied;

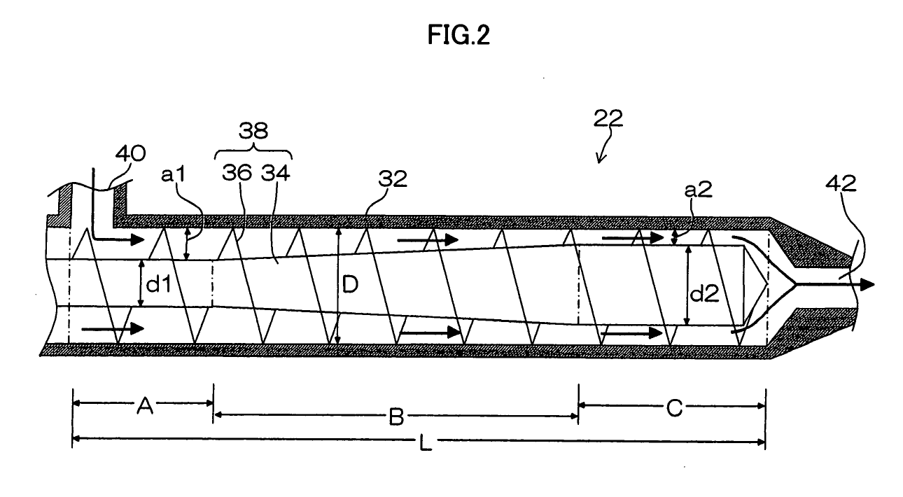

FIG. 2 is a schematic view of the structure of an extruder;

FIG. 3 is a schematic view showing a pair of rollers in a film-forming process unit;

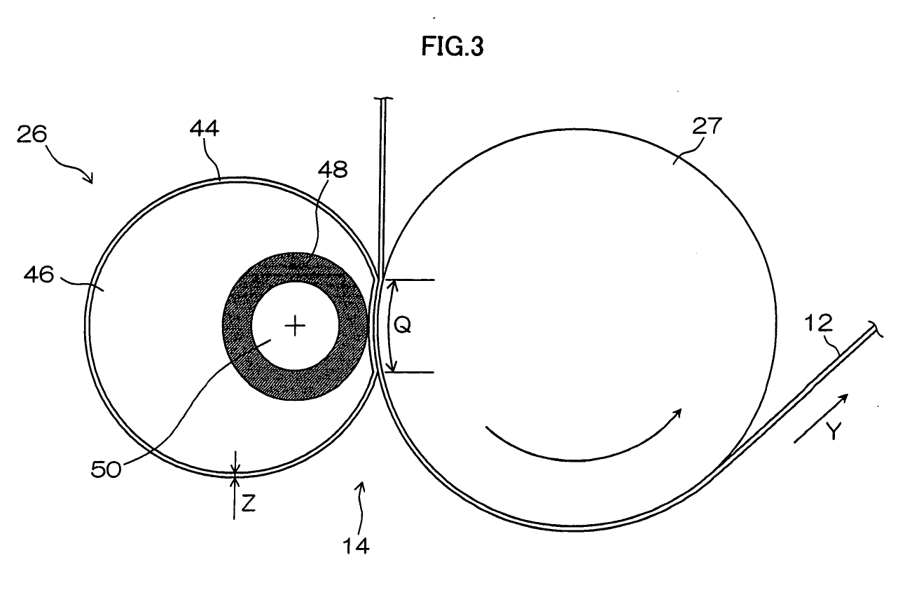

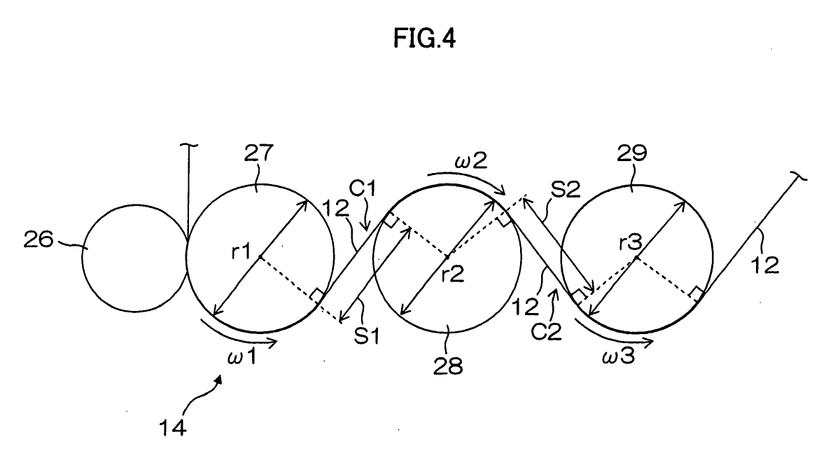

FIG. 4 is a schematic view showing the structure of the film-forming process unit; and

FIGS. 5A and 5B are tables for explaining Examples of the present invention.

### DETAILED DESCRIPTION OF THE PREFERRED EMBODIMENTS

Preferred embodiments of a thermoplastic resin film and a method of manufacturing the film according to the present invention will be explained in accordance with the accompanying stretchings. Note that, in the embodiments, a method of manufacturing a cellulose acylate film as an example of a thermoplastic resin film will be explained. However, the present invention may not be limited to this and applied to manufacturing a saturated norbornene resin film and a polycarbonate resin film. In the embodiments that will be explained below, a film is formed by extruding a resin from a die, and cooling the resin by sandwiching it between a pair of cooling rollers. That is, a film is formed by a touch-roll method. The press roller used herein is an elastic roller made of a metal.

FIG. 1 shows a schematic structure of a thermoplastic resin film-forming apparatus. As is shown in FIG. 1, a film-forming apparatus 10 is principally constituted of a film-forming process unit 14 for manufacturing a cellulose acylate film 12 unstretched, a longitudinal stretching process unit 16 for stretching the cellulose acylate film 12 formed in the film-forming process unit 14 a transverse stretching process unit 18 for stretching the film transversely, and a roll-up step 20 for rolling up the stretched cellulose acylate film 12.

In the film-forming process unit 14, the cellulose acylate resin melted in an extruder 22 is extruded in sheet form from a die 24 and supplied between a pair of rotating rollers 26, 27. The sheet cooled and solidified on the roller 27 is further cooled while being transferred through a plurality of cooling rollers 28, 29. In this manner, the cellulose acylate film 12 is obtained. The cellulose acylate film 12 is removed from the roller 29, fed to the longitudinal stretching process unit 16 and then to transverse stretching process unit 18. The film is stretched in these steps and rolled up into a roll in the roll-up step 20. In this way, the stretched cellulose acylate film 12 is formed. The each of these steps will now be explained below.

FIG. 2 shows a single-screw extruder 22 used in the film-forming process unit 14. As shown in FIG. 2, a single-screw 38 constituting of a screw shaft 34 with a flight 36 is arranged in the cylinder 32. A cellulose acylate resin is supplied from a hopper (not shown) through a supply port 40 into the cylinder 32. The inner space of the cylinder 32 is constituted of three regions represented by reference symbols A, B and C sequentially from the supply port 40. A represents a supply region in which the cellulose acylate resin supplied from the supply port 40 is quantified and transported to the next region. B represents a compression region in which the cellulose acylate resin is kneaded and compressed. C represents a quantification region for quantifying the cellulose acylate resin kneaded and compressed. The cellulose acylate resin melted in the extruder 22 is continuously sent from an extrudion port 42 to the die 24.

The screw compression ratio of the extruder 22 is set at 2.5 to 4.5. The L/D is set at 20 to 50. The screw compression ratio is represented by a volume ratio of the supply region A and the quantification region C, in other words, represented by the following equation:

(the volume per unit length of the supply region A)÷(the volume per unit length of the quantification region C).

More specifically, the screw compression ratio is calculated by using the outer diameter d1 of the screw shaft 34 in the supply region A, the outer diameter d2 of the screw shaft 34 in the quantification region C, the clearance-diameter a1 of the supply region A, and the clearance-diameter a2 of the quantification region C. Furthermore, the L/D used herein is the ratio of the length (L) of the cylinder relative to the inner diameter (D) of the cylinder of FIG. 2. The extrusion temperature of the resin is set at 190 to 240° C. When the temperature of the extruder 22 exceeds 240° C., a cooling unit (not shown) may be better to provide between the extruder 22 and the die 24.

The extruder 22 may be a single screw extruder and a double screw extruder. However, it is not preferable that screw compression ratio is extremely small below 2.5 for the reasons below. First, since a cellulose acylate resin is not sufficiently kneaded, some portion remains unmelted. Second, since heat generated by shearing is low, crystals are not sufficiently melted, with the result that fine crystals are likely to remain in the resultant cellulose acylate film and further air bubbles are likely to enter the film. Accordingly, when such a cellulose acylate film 12 is stretched, the remaining fine crystals inhibit stretching and thus orientational ordering cannot be sufficiently improved. A reverse case where screw compression ratio is extremely large beyond 4.5 is not preferable for the reasons below. First, since shearing stress is excessively applied to the resin and produces heat, with the result that the resin readily deteriorates and changes the color of the resultant cellulose acylate film to yellow. Furthermore, the application of excessive shearing stress causes breakage of molecules and reduces molecular weight of the resin, with the result that the mechanical strength of the film decreases. Therefore, to prevent yellow-change and breakage of the resultant cellulose acylate film by stretching, the screw compression ratio preferably falls within the range of 2.5 to 4.5, more preferably, 2.8 to 4.2, and particularly preferably, 3.0 to 4.0.

When the L/D is extremely small below 20, the resin is not sufficiently melted and kneaded. As a result, fine crystals readily remain in the resultant cellulose acylate film, similarly to the case where the compression ratio is small. Conversely, when the L/D is extremely large over 50, the retention time of the cellulose acylate resin in the extruder 22 is too long, readily causing deterioration of the resin. In addition, the long retention time of the resin causes breakage of molecules and reduces the molecular weight of the resin, with the result that the mechanical strength of the film decreases. Therefore, to prevent yellow-change and breakage of the resultant cellulose acylate film by stretching, the L/D value desirably falls within the range of 20 to 50, preferably, 22 to 45, and particularly preferably, 24 to 40.

When the extrusion temperature is extremely low below 190° C., the crystals are not sufficiently melted and fine crystals readily remain in the resultant cellulose acylate film. As a result, when the cellulose acylate film is stretched, the remaining fine crystals inhibit stretching and thus orientational ordering cannot be sufficiently improved. Conversely, when the extrusion temperature is extremely high over 240° C., the cellulose acylate resin deteriorates and the degree of yellow (YI value) goes to worse. Therefore, to prevent yellow-change and breakage of the resultant cellulose acylate film by stretching, the extrusion temperature desirably falls within the range of 190° C. to 240° C., preferably, 195° C. to 235° C., and particularly preferably, 200° C. to 230° C.

The cellulose acylate resin is melted by the extruder 22 constructed as mentioned above, continuously supplied to the die 24 and extruded from the tip portion (lower edge) of the die 24 in the form of sheet. The zero shear viscosity of the cellulose acylate resin thus extruded is preferably 2000 Pa·sec or less. When the zero shear viscosity exceeds 2000 Pa·sec, the molten resin widely spreads immediately upon extrudion from the die. The molten resin thus spread readily attaches to the tip portion of the die and smears the film in the form of streak. The molten resin extruded is then supplied between the rollers 26, 27 (see FIG. 1).

FIG. 3 shows an embodiment of the rollers 26, 27, which are a press roller 26 and a pressurizing/cooling roller 27, respectively.

The rollers 26, 27 have a mirror surface or virtually a mirror surface having a surface roughness Ra (in terms of an arithmetic average height) of 100 nm or less, preferably 50 nm or less, and further preferably, 25 nm or less. Furthermore, the rollers 26, 27 are constructed so as to control the surface temperature, for example, by circulating a liquid medium such as water inside the rollers 26, 27.

The press roller 26 (of the rollers 26, 27) preferably has a smaller diameter than the pressurizing/cooling roller 27 and the surface thereof is made of a metal material such that the surface temperature can be accurately controlled. The press roller 26 is preferably a metallic elastic roller constituted of a metal cylinder 44 forming the outer shell, a liquid medium layer 46, an elastic layer 48, and metal shaft 50, which are arranged sequentially in this order from the outside. With this constitution, when a molten resin sheet is sandwiched by the pair of rollers 26, 27, the press roller 26 receives counter force from the pressurizing/cooling roller 27 via the sheet and elastically deforms and dents along the surface of the pressurizing/cooling roller 27. In short, the press roller 26 and pressurizing/cooling roller 27 are in surface contact with the sheet at the plane. The sheet sandwiched between the rollers is cooled by the pressurizing/cooling roller 27 while being pressed so as to be flat by reconstitution force of the press roller 26 returning to the original shape. The metal cylinder (outer cylinder) 44 constituting the outer shell is formed of a metal thin-film preferably having a seamless structure (having no junction by welding). The wall thickness Z of the metal cylinder 44 falls within the range of 0.05 mm to 7.0 mm (both not inclusive). When the wall thickness Z of the metal cylinder is 0.05 mm or less, the reconstitution force is low. This is not preferable because not only a surface roughness improving effect is not obtained but also the strength of the roller reduces. In contrast, when the wall thickness Z is 7.0 mm or more, elasticity of the roller cannot be obtained. This is not preferable because residual strain canceling effect cannot be produced. Note that the wall thickness Z of the metal cylinder has no problem as long as it satisfies the range of 0.05 mm<Z<7.0 mm, and more preferably, the range of 0.2 mm<Z<5.0 mm.

Provided that the difference between the glass transition temperature Tg(° C.) of the cellulose acylate resin and the temperature of the elastic roller 26 is represented by X(° C.), and a film-forming speed in the film-forming process by Y (m/min), the film-forming speed Y and the temperature X of the elastic roller 26 are set so as to satisfy the following equation:

0.0043X²+0.12X+1.1<Y<0.019X²+0.73X+24.

When the film-forming speed Y is equal to or less than 0.0043X²+0.12X+1.1, the pressurizing time is so long that the film has residual stress. On the other hand, when the film-forming speed Y is equal to or more than <0.019X²+0.73X+24, the cooling time is so short that the film cannot be gradually cooled and adhered to the press roller 26. For example, when Tg of the cellulose acylate resin is 120° C., the residual stress is induced in the film at a temperature of the press roller 26 of 115° C., 90° C., and 60° C. and at a film-forming speed Y of 1 m/min, 8 m/min, and 23 m/min or less, respectively, whereas the film adheres to the press roller 26 at a film-forming speed Y of 29 m/min, 64 m/min, and 137 m/min or more, respectively. Experiments were performed using various resins to obtain the relationship between X and Y. Note that the temperature of the pressurizing/cooling roller 27 must be within the temperature of the press roller 26±20° C., preferably ±15° C. and further preferably, ±10° C.

Provided that the length of the region at which the pair of rollers 26 and 27 are in contact with each other via the sheet-form resin, is represented by Q (cm) and a line pressure applied by the pair of rollers 26, 27 sandwiching the sheet-form resin is represented by P (kg/cm), the line pressure P and the contact length Q are set so as to satisfy the relationship:

3 kg/cm²<P/Q<50 kg/cm².

When a P/Q value is equal to or less than 3 kg/cm², the pressurizing force applied on the surface of the resin sheet is so low that a surface-roughness improving effect is not produced. In contrast, when a P/Q value is equal to or larger than 50 kg/cm², the pressurizing force is so large that the residual strain is induced in the film, and retardation is generated.

According to the film-forming process unit 14 constructed as mentioned above, a cellulose acylate resin, which is extruded from the die 24, forms a small liquid pool (bank) between the pair of rollers 26, 27. The pool of the resin is then pressed by the pair of roller 26, 27 into a sheet while the thickness of the sheet is controlled. At this time, the press roller 26 receives counter force from the pressurizing/cooling roller 27 via the cellulose acylate resin, and elastically deforms and dents along in accordance with the surface of the pressurizing/cooling roller 27. The cellulose acylate resin is pressurized to be flat by the press roller 26 and pressurizing/cooling roller 27. When the film 12 is formed by sandwiching the resin between the rollers 26, 27 satisfying the aforementioned conditions: wall thickness Z of the metal cylinder, temperature, line pressure, and cooling time, the cellulose acylate film 12 suitable for an optical film free from streaks, improved in dimensional accuracy of thickness, suppressed in residual strain, and low in retardation, can be formed.

A film 12 sandwiched by the pair of rollers 26,27 is stretched on the pressurizing cooling roller 27 to cool, sent to a cooling roller 28 and a cooling roller 29 sequentially, removed from the surface of the cooling roller 29 and sent to the longitudinal stretching process unit 16 downstream.

In this step, the temperatures of the cooling rollers 28, 29 are set to fall within the range of ±3° C. of the temperatures of the film in contact with the respective cooling rollers; at the same time, the temperature of the film removed from the cooling roller 29 (the roller positioned most downstream of the rollers 28, 29) is set at equal to or less than the glass-transition temperature Tg(° C.) of the thermoplastic resin of the film −15° C.

This is because when the resin sheet is cooled by a plurality of rollers 28, 29, in other words, when the temperature of the cooling rollers are set in order to cool and solidify the film 12 on the cooling rollers 28, 29, a big difference in temperature is produced between the cooling roller 28, 29 and the resin sheet when they are in contact with each other, with the result that the resin sheet is abruptly shrunken on the cooling rollers because of temperature difference, and thereby streaks and retardation are induced in the film.

Cooling of the resin sheet is not performed on the cooling rollers 28, 29 but performed in non-contact with them. In other word, the cooling operation is performed while the resin sheet is transferred in the space between them. It is preferable that the difference between the temperature of the resin sheet in contact with the cooling rollers 28, 29 and the temperature of the cooling rollers with which the resin sheet in contact are zero. However, as long as the temperature difference falls within the range of ±3° C., the shrinkage of the resin sheet on the cooling roller can be prevented without fail.

The temperature of the resin sheet removed from the cooling roller 29, which is the roller positioned most downstream of the rollers 28, 29, is set at equal to or less than Tg(° C.) of the thermoplastic resin −15° C. Therefore, the film 12 can be cooled and solidified while transferring the film 12 in the space between the cooling rollers 28, 29.

In this step now, to effectively cool the resin sheet in the space between the cooling rollers, a non-contact type cooling unit (not shown) may be provided.

As described above, since the resin sheet is cooled and solidified not on the cooling rollers but in the space between them, abruptly shrinkage of the resin sheet on the cooling rollers can be prevented. As a result, development of streaks and induction of retardation can be suppressed.

In the pressurizing/cooling roller 27 and cooling rollers 28, 29, provided that the diameter of the roller arranged at the n-th position from the upstream is represented by rₙ (cm), the length of the film between the n-th roller and the (n+1)th roller is represented by Sₙ (cm), the thermal shrinkage of the film between the n-th roller and the (n+1)th roller is represented by cₙ (%), the circumference speed of the n-th cooling roller is represented by ωₙ, these factors preferably satisfy the following relationship:

0.98×(1−cₙ/100)<[(roller circumference speed ratio)=ωₙ₊₁/ωₙ]<1.02×(1−cₙ/100); and

sₙ/rₙ>0.3.

To explain more specifically, in FIG. 4, the circumference speeds of the cooling rollers 28, 29, ω₂, ω₃ are set such that the rate of ω₂/ω₁ satisfies the range of 0.98×(1−c₁/100) to 1.02×(1−c₁/100) and the rate of ω₃/ω₂ satisfies the range of 0.98×(1−c₂/100) to 1.02×(1−c₂/100). Furthermore, the length of the sheet between the rollers is set so as to satisfy the relationship:

s₁/r₁>0.3 and s₂/r₂>0.3

Since the conditions of the cooling rollers 28, 29 are set as mentioned above, the film does not loosen. Furthermore, since the film neither is slid nor stretched on the cooling roller, development of streaks and induction of retardation can be suppressed.

Note that two cooling rollers 28, 29 are used in the embodiment mentioned above; the number of cooling rollers is not limited to these two. As long as at least one cooling roller is used, development of streaks and induction of retardation of the film 12 can be suppressed.

In the film-forming process unit 14 constituted as mentioned above, a cellulose acylate film 12 having a film-thickness of 20 to 300 μm and a in-plane retardation Re of 20 nm or less and a thickness-direction retardation Rth is 20 nm or less can be formed.

The retardation Re and Rth can be obtained by the following equations:

Re (nm)=|n(MD)−n(TD)|×T (nm)

Rth (nm)=|{(n(MD)+n(TD))/2}−n(TH)|×T (nm)

where n(MD), n(TD), and n(TH) denote the refractive indexes in the machine direction, width direction and thickness direction, respectively, and T (nm) denotes the thickness of a film.

The cellulose acylate film 12 formed in the film-forming process unit 14 is stretched in the stretching process to obtain the stretched cellulose acylate film 12. The stretching process will be explained below.

Stretching of the cellulose acylate film 12 is performed to order the molecules of the cellulose acylate film 12 orientationally and thereby in-plane retardation (Re) and thickness-direction retardation (Rth) are induced.

As shown in FIG. 1, the cellulose acylate film 12 is first stretched in the machine direction in a longitudinal stretching process unit 16. In the longitudinal stretching process unit 16, the cellulose acylate film 12 is preheated and the heated cellulose acylate film 12 is stretched over two nip rollers 30, 31. Since the nip roller 31 near the outlet rotates at a higher speed than the nip roller 30 near the inlet, the cellulose acylate film 12 is stretched in the machine direction.

The preheating temperature of the film in the longitudinal stretching process unit 16, is preferably from Tg−40° C. and Tg+60° C. (both inclusive), more preferably, Tg−20° C. and Tg+40° C. (both inclusive), and further preferably, Tg and Tg+30° C. (both inclusive). Furthermore, the stretching temperature of the film in the longitudinal stretching process unit 16 is preferably from Tg to Tg+60° C. (both inclusive), more preferably, Tg+2° C. to Tg+40° C. (both inclusive), and further preferably, Tg+5° C. to Tg+30° C. The stretching rate in the machine direction is 1.0 to 2.5 fold (both inclusive), and further preferably, 1.1 to 2 fold (both inclusive).

The cellulose acylate film 12 stretched in the machine direction is fed to a transverse stretching process unit 18. The cellulose acylate film 12 is stretched in the transverse direction therein. In the transverse stretching process unit 18, for example, a tenter, is suitably used. The cellulose acylate film 12 is stretched transversely in the transverse direction while holding both edges (in the transverse direction) of the cellulose acylate film 12 by clips of the tenter. Owing to the transverse stretching, retardation Rth can be further increased.

The transverse stretching is preferably performed by use of the tenter. The stretching temperature is preferably Tg(° C.) to (Tg+60)° C. (both inclusive), more preferably, (Tg+2)° C. to (Tg+40)° C. (both inclusive), and further preferably, (Tg+4)° C. to (Tg+30)° C. Stretching rate is preferably 1.0 fold to 2.5 fold (both inclusive) and further preferably, 1.1 to 2.0 fold (both inclusive). After completion of the transverse stretching, the film is preferably relaxed in either one or both of the machine direction or the transverse direction. In this manner, the distribution of the slow-phase axes in the width direction can be reduced.

As a result of the stretching, an Re value (in terms of absolution value) falls preferably within the range of 500 nm or less, more preferably, 10 nm to 400 nm (both inclusive), and further preferably, 15 nm to 300 nm (both inclusive); and an Rth value (in terms of absolution value) falls preferably within the range of 0 nm to 500 nm (both inclusive), more preferably, 50 nm to 400 nm (both inclusive) and, further preferably, 70 nm to 350 nm (both inclusive).

Of these films, a film satisfying the relationship Re≦Rth is more preferable and satisfying the relationship Re x2≦Rth is further preferable. To attain high Rth and low Re, it is preferable that the film stretched in the machine direction is stretched transversely (in the width direction). The difference in orientation between the machine direction and the transverse direction becomes the difference of in-plane retardation (Re). The in-plane orientation (Re) can be reduced by reducing the difference in orientation between the machine direction and transverse direction by stretching the film not only in the machine direction but also in the transverse direction (in perpendicular to the machine direction). On the other hand, since stretching is performed not only in the machine direction but also in the transverse direction, the rate of the area after to before stretching increases. As the thickness decreases, the degree of orientation in the thickness direction increases. In this way, Rth increases.

Furthermore, positional variations in Re and Rth in the width direction and the machine direction are 10% or less, preferably, 8% or less, more preferably, 6% or less, further preferably, 4% or less and most preferably 2% or less.

The positional variation in thickness in the width direction and the machine direction are 10% or less, preferably, 8% or less, more preferably, 6% or less, further preferably, 4% or less and most preferably 2% or less.

Note that variation in thickness and Re and Rth can be obtained as follows.

A 10-meter sample film is taken from the stretched cellulose acylate film 12. After both edges (corresponding to 20%) of the sample film in the film-width direction are removed, samples are taken from 50 points of the film arranged at regular intervals from the center in the width direction and in the machine direction. The thickness, Re and Rth of each of the samples are determined. Note that Re and Rth can be determined by an automatic birefringence analyzer (KOBRA-21ADH manufactured by Oji Scientific Instrument).

An average width value (Th_{TD-av}) of the film in the width direction, the maximum value (Th_{TD-max}) and the minimum value (Th_{TD-min}) are obtained. A variation of the thickness in the width direction is obtained by the following equation:

(Th_{TD-max}−Th_{TD-min})÷Th_{TD-av}×100%.

Furthermore, an average width value (Th_{MD-av}) of the film in the longitudinal (machine) direction, the maximum value (Th_{MD-max}) and the minimum value (Th_{MD-min}) are obtained. A variation of the thickness in the longitudinal (machine) direction is obtained by the following equation:

(Th_{MD-max}−Th_{MD-min})÷Th_{MD-av}×100%.

With respect to Re and Rth, an average value of Re (Re_{TD-av}) and an average value of Rth (Rth_{TD-av}) in the width direction and the maximum values (Re_{TD-max}) (Rth_{TD-max}) and the minimum values (Re_{TD-min}) (Rth_{TD-min}) are obtained. Variations of Re_{TD}, Re_{MD}, Rth_{TD}, Rth_{MD} (in terms of an absolute value) can be obtained in the same calculation manner as mentioned above.

As described above, according to the embodiment, the cellulose acylate film 12 formed herein can be improved in dimensional accuracy in thickness and therefore, an optical film uniform in optical properties in the width direction and longitudinal direction can be obtained.

The cellulose acylate film 12 having been stretched is wound up in the form of a roll in the winding-up section 20 in FIG. 1. In this winding up, the winding-up tension of the cellulose acylate film 12 is preferably set at 0.02 kg/mm² or less. The winding-up tension set to fall within such a range permits winding up of the stretched cellulose acylate film 12 without generating any retardation distribution in the stretched cellulose acylate film 12.

Hereinafter, detailed description will be made on the cellulose acylate resin suitable for the present invention, the film formation method of the unstretched cellulose acylate film 12, and the processing method of the cellulose acylate film 12, according to the sequence of procedures.

### (Cellulose Acylate Resin)

The cellulose acylate to be used in the present invention is preferably characterized as follows. Here, A represents the substitution degree of the acetyl group and B represents the total sum of the substitution degrees of the acyl groups each having 3 to 7 carbon atoms.

2.0≦A+B≦3.0 (1)

0≦A≦2.0 (2)

1.2≦B≦2.9 (3)

In the cellulose acylate of the present invention, as shown by the above formula (1), A+B is characterized by satisfying the relation that A+B is from 2.0 to 3.0; A+B is preferably from 2.4 to 3.0 and more preferably from 2.5 to 2.95. When A+B is less than 2.0, the hydrophilicity of the cellulose acylate is increased and the moisture permeability of the film is unpreferably increased.

It is to be noted that the numerical value range defined by using “from” and “to” means that the range includes the numerical value following “from” and the numerical value following “to” as the lower and upper limits, respectively.

As shown by the above formula (2), A is characterized by satisfying the relation that A is from 0 to 2.0; A is preferably from 0.05 to 1.8 and more preferably from 0.1 to 1.6.

As shown by the above formula (3), B is characterized by satisfying the relation that B is from 1.2 to 2.9; B is preferably from 1.3 to 2.9, more preferably from 1.4 to 2.9 and furthermore preferably from 1.5 to 2.9.

When the half or more of B is the propionate group, it is preferable that:

2.4≦A+B≦3.0

2.0≦B≦2.9;

when less than the half of B is the propionate group, it is preferable that:

2.4≦A+B≦3.0

1.3≦B≦2.5.

when the half or more of B is the propionate group, it is further preferable that:

2.5≦A+B≦2.95

2.4≦B≦2.9;

when less than the half of B is the propionate group, it is further preferable that:

2.5≦A+B≦2.95

1.4≦B≦2.0.

The present invention is characterized in that the substitution degree of an acetyl group occupied in the acyl group is reduced and the sum of the substitution degree of a propionyl group, butyryl group, pentanoyl group and hexanoyl group is increased. By virtue of this, variations of Re and Rth with the passage of time after stretching can be reduced. This is because the flexibility of the film and stretching properties thereof can be improved by the larger content of these groups having a larger (molecular) length than the acetyl group, with the result that the orientational ordering of the cellulose acylate molecules is rarely disturbed with stretching and accordingly the variation of Re and Rth can be reduced with the passage of time. However, it is not preferable to use an acyl group having a larger number of carbon atoms than the aforementioned groups because the grass transition temperature (Tg) and the elastic modulus excessively decrease. Preferable examples of the acyl groups having 3 to 7 carbon atoms (based on which degree of substation B is calculated) may include propionyl, butyryl, 2-methylpropionyl, pentanoyl, 3-methylbutyryl, 2-methylbutyryl, 2,2-dimethylpropionyl(pivaloyl), hexanoyl, 2-methylpentanoyl, 3-methylpentanoyl, 4-methylpentanoyl, 2,2-dimethylbutyryl, 2,3-dimethylbutyryl, 3,3-dimethylbutyryl, cyclopentanecarbonyl, heptanoyl, cyclohexanecarbonyl and benzoyl. More preferable examples thereof include propionyl, butyryl, pentanoyl, hexanoyl, and benzoyl. Particularly preferable examples thereof are propionyl and butyryl.

The fundamental principles of the process for synthesizing these cellulose acylates are described by Migita et al. in “Mokuzai Kagaku (Wood Chemistry),” pp. 180-190 (Kyoritsu Shuppan, 1968). A typical synthesis method is a liquid phase acetylation method involving a carboxylic anhydride, acetic acid and sulfuric acid as catalyst. Specifically, a cellulose raw material such as cotton linter and wood pulp is pretreated with an appropriate amount of acetic acid, and then subjected to esterification by placing the pretreated cellulose raw material in a precooled liquid mixture for carboxylation to thereby synthesize a perfect cellulose acylate (the sum of the substitution degrees of the acyl groups at the 2-, 3- and 6-position amounting to almost 3.00). The liquid mixture for carboxylation generally contains acetic acid as solvent, a carboxylic anhydride as an esterifying agent and sulfuric acid as catalyst. It is a common practice to use the carboxylic anhydride in a stoichiometrically excess amount in relation to the sum of the amount of the cellulose to be reacted with the carboxylic anhydride and the amount of the moisture in the reaction system. After completion of the acylation reaction, an aqueous solution of a neutralizing agent (for example, the carbonate, acetate or oxide of calcium, magnesium, iron, aluminum or zinc) is added to hydrolyze the excessive carboxylic anhydride remaining in the reaction system and neutralize a fraction of the esterification catalyst. Then, the obtained perfect cellulose acylate is saponified and aged by maintaining at from 50 to 90° C. in the presence of a small amount of an acetylation catalyst (in general, the remaining sulfuric acid) to thereby convert the perfect cellulose acylate into a cellulose acylate having a desired substitution degree of acyl and a desired polymerization degree. When the desired cellulose acylate is obtained, the catalyst remaining in the reaction system is completely neutralized by using such a neutralizing agent as described above. Alternatively, the cellulose acylate solution is poured, without being neutralized, into water or a diluted sulfuric acid (or water or a diluted sulfuric acid is poured into the cellulose acylate solution) to separate the cellulose acylate; the separated cellulose acylate is washed and subjected to a stabilization treatment to yield the desired cellulose acylate.

The number average molecular weight of the cellulose acylate to be preferably used in the present invention is required to be from 20,000 to 80,000, preferably from 30,000 to 75,000 and further preferably from 40,000 to 70,000. When the molecular weight is smaller than 20,000, the mechanical properties of the film are insufficient, and unpreferably the film tends to crack. On the other hand, when the molecular weight is large to exceed 80,000, the melt viscosity at the time of melt film-forming unpreferably becomes too high. The control of the average polymerization degree can also be attained by removing low-molecular weight components. When the low-molecular weight components are removed, the average molecular weight (polymerization degree) is increased, but the viscosity becomes lower than those of common cellulose acylates; therefore the removal of the low-molecular weight components is useful. The removal of the low-molecular weight components can be carried out by washing the cellulose acylate with an appropriate organic solvent. Moreover, the molecular weight can also be controlled by the polymerization method. For example, when a cellulose acylate containing smaller amounts of low-molecular weight components is produced, the amount of the sulfuric acid catalyst in the acetylation reaction is preferably controlled to be from 0.5 to 25 parts by weight in relation to 100 parts by weight of the cellulose. The control of the amount of the sulfuric acid catalyst to fall within this range makes it possible to synthesize a cellulose acylate that is also satisfactory from the viewpoint of the molecular weight distribution (a cellulose acylate having a uniform molecular weight distribution).

In the present invention, the weight average polymerization degree/number average polymerization degree of the cellulose acylate measured by GPC (Gel Permeation Chromatography) is preferably 2.0 to 5.0, further preferably, 2.2 to 4.5, and particularly preferably 2.4 to 4.0.

The cellulose acylate of the present invention is improved in heat stability by regulating the amount of a remaining sulfate radical within the range of 0 to 100 ppm. When a cellulose acylate film is obtained from such a cellulose acylate by the melting film-forming method is not colored. As a result, an optical film made of the cellulose acylate film is excellent in transparency.

These cellulose acylates may be used singly or as mixtures of two or more thereof. Alternatively, a polymer component other than the cellulose acylate may be optionally mixed together. The polymer component to be mixed with the cellulose acylate preferably has an excellent compatibility with the cellulose acylate, and the film produced by mixing the polymer component has a transmittance of preferably 80% or more, further preferably 90% or more and furthermore preferably 92% or more.

In the present invention, addition of a plasticizer can preferably decrease the crystal melting point (Tm) of the cellulose acylate, and can also preferably alleviate the fluctuations of Re and Rth with time. This is because the addition of a plasticizer hydrophobilizes the cellulose acylate, and can thereby suppress the relaxation of the stretching orientation of the cellulose acylate molecules due to water absorption. No particular constraint is imposed on the molecular weight of the plasticizer to be used, and the plasticizer may have a high or low molecular weight. Examples of the plasticizer may include phosphoric acid esters, alkyl phthalyl alkyl glycolates, carboxylic acid esters and fatty acid esters of polyhydric alcohols. The form of each of these plasticizers may be solid or oily. In other words, no particular constraint is imposed on the melting point or the boiling point of each of these plasticizers. When the melt film-forming is carried out, a nonvolatile plasticizer can be particularly preferably used.

Specific examples of the phosphoric acid ester may include triphenyl phosphate, tributyl phosphate, tributoxyethyl phosphate, tricresyl phosphate, trioctyl phosphate, trinaphthyl phosphate, trixylyl phosphate, tri-o-biphenyl phosphate, cresyl diphenyl phosphate, octyl diphenyl phosphate, biphenyl diphenyl phosphate, and 1,4-phenylene tetraphenyl phosphate. Alternatively, phosphoric acid ester plasticizers described in the claims 3 to 7 of Japanese Patent Laid-Open No. 6-501040 are also preferably used.

Examples of the alkyl phthalyl alkyl glycolates may include methyl phthalyl methyl glycolate, ethyl phthalyl ethyl glycolate, propyl phthalyl propyl glycolate, butyl phthalyl butyl glycolate, octyl phthalyl octyl glycolate, methyl phthalyl ethyl glycolate, ethyl phthalyl methyl glycolate, ethyl phthalyl propyl glycolate, methyl phthalyl butyl glycolate, ethyl phthalyl butyl glycolate, butyl phthalyl methyl glycolate, butyl phthalyl ethyl glycolate, propyl phthalyl butyl glycolate, butyl phthalyl propyl glycolate, methyl phthalyl octyl glycolate, ethyl phthalyl octyl glycolate, octyl phthalyl methyl glycolate, and octyl phthalyl ethyl glycolate.

Examples of the carboxylic acid esters may include: phthalates such as dimethyl phthalate, diethyl phthalate, dibutyl phthalate, dioctyl phthalate and diethylhexyl phthalate; citrates such as acetyltrimethyl citrate, acetyltriethyl citrate and acetyltributyl citrate; adipates such as dimethyl adipate, dibutyl adipate, diisobutyl adipate, bis(2-ethylhexyl) adipate, diisodecyl adipate, and bis(butyldiglycol) adipate; aromatic polycarboxylic acid esters such as tetraoctyl pyromellitate, trioctyl trimellitate; aliphatic polycarboxylic acid esters such as dibutyl adipate, dioctyl adipate, dibutyl sebacate, dioctyl sebacate, diethyl azelate, dibutyl azelate and dioctyl azelate; fatty acid esters of polyhydric alcohols such as glycerin triacetate, diglycerin tetraacetate, acetylated glyceride, monoglycerides and diglycerides. Additionally, butyl oleate, methyl acetyl ricinoleate, dibutyl sebacate, triacetin and the like are preferably used singly or in combinations.

Examples of the plasticizers may also include the following high molecular weight plasticizers: aliphatic polyesters each composed of a glycol and a dibasic acid such as polyethylene adipate, polybutylene adipate, polyethylene succinate, and polybutylene succinate; aliphatic polyesters each composed of an oxycarboxylic acid such as polylactic acid and polyglycolic acid; aliphatic polyesters each composed of a lactone such as polycaprolactone, polypropiolactone and polyvalerolactone; and vinyl polymers such as polyvinyl pyrrolidone. As the plasticizer, these high molecular weight plasticizers may be used singly or in combinations with low molecular weight plasticizers.

Examples of polyhydric alcohol plasticizers may include the following compounds that are satisfactory in compatibility with fatty acid esters of cellulose and exhibit remarkable thermoplastic effect: glycerin ester compounds such as glycerin esters and diglycerin esters; polyalkylene glycols such as polyethylene glycol and polypropylene glycol; and those compounds in each of which a polyalkylene glycol has acyl groups bonded to the hydroxy groups thereof.

Specific examples of glycerin esters include: not limited to, glycerin diacetate stearate, glycerin diacetate palmitate, glycerin diacetate mystirate, glycerin diacetate laurate, glycerin diacetate caprate, glycerin diacetate nonanate, glycerin diacetate octanoate, glycerin diacetate heptanoate, glycerin diacetate hexanoate, glycerin diacetate pentanoate, glycerin diacetate oleate, glycerin acetate dicaprate, glycerin acetate dinonanate, glycerin acetate dioctanoate, glycerin acetate diheptanoate, glycerin acetate dicaproate, glycerin acetate divalerate, glycerin acetate dibutyrate, glycerin dipropionate caprate, glycerin dipropionate laurate, glycerin dipropionate mystirate, glycerin dipropionate palmitate, glycerin dipropionate stearate, glycerin dipropionate oleate, glycerin tributyrate, glycerin tripentanoate, glycerin monopalmitate, glycerin monostearate, glycerin distearate, glycerin propionate laurate, and glycerin oleate propionate. Either any one of these glycerin esters alone or two or more of them in combination may be used.

Of these examples, preferable are glycerin diacetate caprylate, glycerin diacetate pelargonate, glycerin diacetate caprate, glycerin diacetate laurate, glycerin diacetate myristate, glycerin diacetate palmitate, glycerin diacetate stearate, and glycerin diacetate oleate.

Specific examples of diglycerin esters include: not limited to, mixed acid esters of diglycerin, such as diglycerin tetraacetate, diglycerin tetrapropionate, diglycerin tetrabutyrate, diglycerin tetravalerate, diglycerin tetrahexanoate, diglycerin tetraheptanoate, diglycerin tetracaprylate, diglycerin tetrapelargonate, diglycerin tetracaprate, diglycerin tetralaurate, diglycerin tetramystyrate, diglycerin tetramyristylate, diglycerin tetrapalmitate, diglycerin triacetate propionate, diglycerin triacetate butyrate, diglycerin triacetate valerate, diglycerin triacetate hexanoate, diglycerin triacetate heptanoate, diglycerin triacetate caprylate, diglycerin triacetate pelargonate, diglycerin triacetate caprate, diglycerin triacetate laurate, diglycerin triacetate mystyrate, diglycerin triacetate palmitate, diglycerin triacetate stearate, diglycerin triacetate oleate, diglycerin diacetate dipropionate, diglycerin diacetate dibutyrate, diglycerin diacetate divalerate, diglycerin diacetate dihexanoate, diglycerin diacetate diheptanoate, diglycerin diacetate dicaprylate, diglycerin diacetate dipelargonate, diglycerin diacetate dicaprate, diglycerin diacetate dilaurate, diglycerin diacetate dimystyrate, diglycerin diacetate dipalmitate, diglycerin diacetate distearate, diglycerin diacetate dioleate, diglycerin acetate tripropionate, diglycerin acetate tributyrate, diglycerin acetate trivalerate, diglycerin acetate trihexanoate, diglycerin acetate triheptanoate, diglycerin acetate tricaprylate, diglycerin acetate tripelargonate, diglycerin acetate tricaprate, diglycerin acetate trilaurate, diglycerin acetate trimystyrate, diglycerin acetate trimyristylate, diglycerin acetate tripalmitate, diglycerin acetate tristearate, diglycerin acetate trioleate, diglycerin laurate, diglycerin stearate, diglycerin caprylate, diglycerin myristate, and diglycerin oleate. Either any one of these diglycerin esters alone or two or more of them in combination may be used.

Of these examples, diglycerin tetraacetate, diglycerin tetrapropionate, diglycerin tetrabutyrate, diglycerin tetracaprylate and diglycerin tetralaurate are preferably used.

Specific examples of polyalkylene glycols include: not limited to, polyethylene glycols and polypropylene glycols having an average molecular weight of 200 to 1000. Either any one of these examples or two of more of them in combination may be used.

Specific examples of compounds in which an acyl group is bound to the hydroxyl group of polyalkylene glycol include: not limited to, polyoxyethylene acetate, polyoxyethylene propionate, polyoxyethylene butyrate, polyoxyethylene valerate, polyoxyethylene caproate, polyoxyethylene heptanoate, polyoxyethylene octanoate, polyoxyethylene nonanate, polyoxyethylene caprate, polyoxyethylene laurate, polyoxyethylene myristylate, polyoxyethylene palmitate, polyoxyethylene stearate, polyoxyethylene oleate, polyoxyethylene linoleate, polyoxypropylene acetate, polyoxypropylene propionate, polyoxypropylene butyrate, polyoxypropylene valerate, polyoxypropylene caproate, polyoxypropylene heptanoate, polyoxypropylene octanoate, polyoxypropylene nonanate, polyoxypropylene caprate, polyoxypropylene laurate, polyoxypropylene myristylate, polyoxypropylene palmitate, polyoxypropylene stearate, polyoxypropylene oleate, and polyoxypropylene linoleate. Either any one of these examples or two or more of them in combination may be used.

The addition amount of the plasticizer is preferably from 0 to 20% by weight, more preferably from 2 to 18% by weight and most preferably from 4 to 15% by weight. When the addition amount of the plasticizer exceeds 20% by weight, the thermal fluidity of the cellulose acylate becomes satisfactory, but the plasticizer sometimes bleeds from the surface of a film made by melt film-forming, or the glass transition temperature Tg as an indicator of the heat resistance is lowered.

In the present invention, if needed, as the stabilizers for inhibiting thermal degradation and coloration, phosphite compounds, phosphorous acid ester compounds, phosphates, thiophosphates, weak organic acids, epoxy compounds and the like may be added singly or as mixtures of two or more thereof, within such ranges that do not impart the required performances. Specific examples of more preferably usable phosphite stabilizers may include the compounds described in the paragraphs from [0023] to [0039] in Japanese Patent Laid-Open No. 2004-182979. Specific examples of usable phosphorous acid ester stabilizers may include the compounds described in Japanese Patent Laid-Open Nos. 51-70316, 10-306175, 57-78431, 54-157159 and 55-13765.

The addition amount of the stabilizer in the present invention is preferably from 0.005 to 0.5% by weight, more preferably from 0.01 to 0.4% by weight, and furthermore preferably from 0.05 to 0.3% by weight, in relation to the cellulose acylate. When the addition amount is less than 0.005% by weight, unpreferably the effects of inhibiting degradation and suppressing coloration in the melt film-forming are insufficient. On the other hand, when the addition amount exceeds 0.5% by weight, unpreferably the stabilizer bleeds from the surface of the cellulose acylate film formed by melt film-forming.

Degradation inhibitors and antioxidants are also preferably added. Synergetic effects of inhibiting degradation and oxidation are displayed by adding, as degradation inhibitors or antioxidants, phenolic compounds, thioether compounds, phosphorus compounds and the like. Further, examples of preferably usable stabilizers may include the materials described in detail in Hatsumei Kyokai Kokai Giho (Ko-Gi No. 2001-1745; published date: Mar. 15, 2001; Hatsumei Kyokai) pp. 17-22.

The cellulose acylate of the present invention is characterized by including ultraviolet protecting agents, and may be added with one or more ultraviolet absorbers. Ultraviolet absorbers for liquid crystal are preferably excellent in absorbing ability for the ultraviolet light of 380 nm or less in wavelength from the viewpoint of inhibiting degradation of liquid crystal, and low in absorbing ability for the visible light of 400 nm or more in wavelength from the view point of liquid crystal display quality. Examples of such ultraviolet absorbers may include oxybenzophenone compounds, benzotriazole compounds, salicylic acid ester compounds, benzophenone compounds, cyanoacrylate compounds and nickel complex compounds. Particularly preferred ultraviolet absorbers are benzotriazole compounds and benzophenone compounds. Among these, benzotriazole compounds are preferable because of being low in undesirable coloration for the cellulose acylate.

Examples of preferable ultraviolet protecting agents may include: 2,6-di-tert-butyl-p-cresol, pentaerythrityl-tetrakis-[3-(3,5-di-tert-butyl-4-hydroxyphenyl) propionate], triethyleneglycol-bis[3-(3-tert-butyl-5-methyl-4-hydroxyphenyl) propionate], 1,6-hexanediol-bis-[3-(3,5-di-tert-butyl-4-hydroxyphenyl)propionate], 2,4-bis-(n-octylthio)-6-(4-hydroxy-3,5-di-tert-butylanilino)-1,3,5-triazine, 2,2-thio-diethylenebis[3-(3,5-di-tert-butyl-4-hydroxyphenyl)propionate], octadecyl-3-(3,5-di-tert-butyl-4-hydroxyphenyl)propionate, N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, and tris-(3.5-di-tert-butyl-4-hydroxybenzyl)-isocyanurate.

Further examples of preferable ultraviolet protecting agents may include: 2-(2′-hydroxy-5′-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′,5′-di-tert-butylphenyl)-5-chlorobenzotriazole, 2-(2′-hydroxy-3′-(3″,4″,5″,6″-tetrahydrophthalimidemethyl)-5′-methylphenyl)benzotriazole, 2,2-methylenebis(4-(1,1,3,3-tetramethylbutyl)-6-(2H-benzotriazol-2-yl)phenol, 2-(2′-hydroxy-3′-tert-butyl-5′-methylphenyl)-5-chlorobenzotriazole, 2-(2H-benzotriazol-2-yl)-6-(straight chain and branched dodecyl)-4-methylphenol, and a mixture composed of octyl-3-[3-tert-butyl-4-hydroxy-5-(chloro-2H-benzotriazol-2-yl)phenyl]propionate and 2-ethylhexyl-3-[3-tert-butyl-4-hydroxy-5-(5-chloro-2H-benzotriazol-2-yl)phenyl]propionate. Additionally, examples of preferably usable ultraviolet absorbers may also include polymer ultraviolet absorbers and polymer-type ultraviolet absorbers described in Japanese Patent Laid-Open No. 6-148430.

Also preferable are 2,6-di-tert-butyl-p-cresol, pentaerythrityl-tetrakis-[3-(3,5-di-tert-butyl-4-hydroxyphenyl)propionate], and triethyleneglycol-bis[3-(3-tert-butyl-5-methyl-4-hydroxyphenyl)propionate]. Hydrazine metal deactivators such as N,N′-bis[3-(3,5-di-tert-butyl-4-hydroxyphenyl)propionyl]hydrazine and phosphorus-containing processing stabilizers such as tris(2,4-di-tert-butylphenyl)phosphite may also be used in combination. The addition amounts of these compounds are, in terms of mass ratio, preferably from 1 ppm to 3.0% and more preferably from 10 ppm to 2% in relation to the cellulose acylate.

For the above described ultraviolet absorbers, the following usable products are commercially available: benzotriazole ultraviolet absorbers such as Tinuvin P, Tinuvin 234, Tinuvin 320, Tibuvin 326, Tinuvin 327 and Tinuvin 328 (Ciba Specialty Chemicals), and Sumisoap 340 (Sumitomo Chemical); benzophenone ultraviolet absorbers such as Seasoap 100, Seasoap 101, Seasoap 101S, Seasoap 102 and Seasoap 103 (Sipro Kasei), ADK Stab LA-51 (Asahi Denka), Chemisoap 111 (Chemipro Kasei) and Uvinul D-49 (BASF); oxalic acid anilide ultraviolet absorbers such as Tinuvin 312 and Tinuvin 315 (Ciba Specialty Chemicals); salicylic acid ultraviolet absorbers such as Seasoap 201 and Seasoap 202 (Sipro Kasei); and cyanoacrylate ultraviolet absorbers such as Seasoap 501 (Sipro Kasei) and Uvinul N-539 (BASF).

Further, there may be added various additives (for example, optical anisotropy controlling agents, fine particulate materials, infrared absorbers, surfactants, and odor trapping agents (amines and the like)). Examples of the usable infrared absorbers may include the infrared absorbing dyes described in Japanese Patent Laid-Open No. 2001-194522, each of these infrared absorbers being contained preferably in a content of 0.001 to 5% by mass in relation to the cellulose acylate. Fine particulate materials made of metal oxides or cross-linked polymers can be used; such materials of 5 to 3000 nm in average particle size are preferably used and are preferably contained in a content of 0.001 to 5% by mass in relation to cellulose acylate. Examples of the usable optical anisotropy controlling agents may include those described in Japanese Patent Laid-Open Nos. 2003-66230 and 2002-49128; such an agent is preferably contained in a content of 0.1 to 15% by mass in relation to the cellulose acylate.

### <Melt Film-Forming Method>

### (1) Dehydration Step

The cellulose acylate resin may be used as it is in a state of a powder, but a pelletized cellulose acylate resin is more preferably used for the purpose of suppressing the thickness fluctuation of the formed film.

The cellulose acylate resin is made to have a moisture content of 1% or less, more preferably 0.5% or less and furthermore preferably 0.1% or less, and then placed in the hopper equipped with the extruder, when the temperature of the hopper is set preferably at Tg−50° C. or higher and Tg+30° C. or lower, more preferably at Tg−40° C. or higher and Tg+10° C. or lower, and furthermore preferably at Tg−30° C. or higher and Tg or lower. The reabsorption of the moisture in the hopper is thereby suppressed to make it possible to easily attain the efficiency of the above described drying. Further, it is also more preferable to blow dehumidified air or an inert gas (for example, nitrogen) into the hopper.

### (2) Kneading/Extrusion Step

The dried cellulose acylate resin is kneaded to be melted preferably at 190° C. or higher and 240° C. or lower, more preferably at 195° C. or higher and 235° C. or lower, and furthermore preferably 200° C. or higher and 230° C. or lower. In this case, melting may be carried out at a constant melting temperature, or at several separately controlled temperatures. The kneading time is preferably 2 minutes or more and 60 minutes or less, more preferably 3 minutes or more and 40 minutes or less, and furthermore preferably 4 minutes or more and 30 minutes or less. Additionally, the kneading and melting are carried out preferably in a flow of an inert gas (nitrogen or the like) introduced into the extruder, or preferably under vacuum evacuation with an extruder equipped with a vent.

### (3) Casting Step

The molten cellulose acylate resin is made to pass through gear pump to dampen the pulsation due to the extruder, then subjected to filtration with a metal mesh filter or the like, and is extruded in the form of a sheet from a T-shaped die, disposed at a position downstream of the filter, onto the cooling drum. The extrusion may be carried out in a single layer mode, or may be carried out in a multilayer mode with a multi-manifold die or a feed block die. In the extrusion, by controlling the interval between the lips of the die, the transverse thickness nonuniformity can be controlled.

Thereafter, the resin is extruded on the cooling drum by use of a touch roll method.

The resin is preferably cooled and solidified by sandwiching it by a pair of rollers having a surface roughness Ra of 100 nm or less in terms of an arithmetic average height. The cooling roller having an arithmetic average surface roughness Ra of beyond 100 nm is not preferable because the transparency of the resultant resin film decreases. The surface roughness is preferably 50 nm or less, and further preferably, 25 nm.

The temperature of the cooling drum is preferably 60° C. or higher and 160° C. or lower, more preferably 70° C. or higher and 150° C. or lower, and furthermore preferably 80° C. or higher and 140° C. or lower. Then, the sheet is peeled from the cooling drum, treated with niprolls with a tenter, and wound up. The winding-up speed is preferably 10 m/min or more and 100 m/min or less, more preferably 15 m/min or more and 80 m/min or less, and furthermore preferably 20 m/min or more and 70 m/min less.

The width of the formed film is preferably 1 m or more and 5 m or less, more preferably 1.2 m or more and 4 m or less, and furthermore preferably 1.3 m or more and 3 m or less. The thickness of the unstretched cellulose acylate film thus obtained is preferably 30 μm or more and 300 μm or less, more preferably 40 μm or more and 250 μm or less, and furthermore preferably 50 μm or more and 200 μm or less.

The cellulose acylate film 12 thus obtained is trimmed at both edges and rolled up by a winder for a time. The trimmed portions are pulverized and subjected to palletizing treatment, depolymerization/re-polymerization according to need, and may be reused as a raw material for forming the same or different type of cellulose acylate film. Before subjecting to the winder, a masking film is preferably applied to one of the surfaces of the cellulose acylate film in view of preventing damage of the film.

The glass transition temperature (Tg) of the cellulose acylate film thus obtained is preferably 70° C. or higher and 180° C. or lower, more preferably 80° C. or higher and 160° C. or lower, and furthermore preferably 90° C. or higher and 150° C. or lower.

### <Processing of Cellulose Acylate Film>

The cellulose acylate film formed by means of the above described process is stretched uniaxially or biaxially by means of the above described process to produce a stretched cellulose acylate film. This film may be used alone, in combination with a sheet polarizer, with a liquid crystal layer or a layer controlled in refractive index (low reflection layer) disposed thereon, or with a hard coat layer disposed thereon. These uses are achieved by the following process.

### (1) Surface Processing

Surface treatment of the cellulose acylate film improves the adhesion thereof to various functional layers (for example, a primer layer or a back layer). For that purpose, for example, there can be used the glow discharge treatment, the ultraviolet irradiation treatment, the corona treatment, the flame treatment or the acid or alkali treatment. The glow discharge treatment as referred to herein may use a low temperature plasma to occur under a low pressure gas of 10⁻³ to 10⁻²⁰ Torr, or is preferably a plasma treatment under atmospheric pressure. The plasma excitation gas means a gas undergoing plasma excitation under such conditions as above described; examples of such gas may include argon, helium, neon, krypton, xenon, nitrogen, carbon dioxide, chlorofluorocarbons such as tetrafluoromethane and mixtures thereof. These gases are described in detail in Hatsumei Kyokai Kokai Giho (Ko-Gi No. 2001-1745; published date: Mar. 15, 2001; Hatsumei Kyokai) pp. 30-32. In a plasma treatment under atmospheric pressure, recently attracting attention, there is used an irradiation energy of 20 to 500 kGy under from 10 to 1000 keV, and more preferably from 20 to 300 kGy under from 30 to 500 keV. Particularly preferred among these treatments is the alkali saponification treatment.

Alkali saponification may be carried out by immersing the film in a saponifying solution (immersing method) or by coating the film with a saponifying solution. The saponification by immersion can be achieved by allowing the film to pass through a bath, in which an aqueous solution of NaOH or KOH with pH of 10 to 14 has been heated to 20° C. to 80° C., over 0.1 to 10 minutes, neutralizing the same, water-washing the neutralized film, followed by drying.

The saponification by coating can be carried out using a coating method such as dip coating, curtain coating, extrusion coating, bar coating or E-coating. A solvent for alkali-saponification solution is preferably selected from solvents that allow the saponifying solution to have excellent wetting characteristics when the solution is applied to a transparent substrate; and allow the surface of a transparent substrate to be kept in a good state without causing irregularities on the surface. Specifically, alcohol solvents are preferable, and isopropyl alcohol is particularly preferable. An aqueous solution of surfactant can also be used as a solvent. As an alkali for the alkali-saponification coating solution, an alkali soluble in the above described solvent is preferable, and KOH or NaOH is more preferable. The pH of the alkali-saponification coating solution is preferably 10 or more and more preferably 12 or more. Preferably, the alkali saponification reaction is carried at room temperature for 1 second or longer and 5 minutes or shorter, more preferably for 5 seconds or longer and 5 minutes or shorter, and particularly preferably for 20 seconds or longer and 3 minutes or shorter. It is preferable to wash the saponifying solution-coated surface with water or an acid and wash the surface with water again after the alkali saponification reaction. The coating-type saponification and the removal of orientation layer described later can be performed continuously, whereby the number of the manufacturing steps can be decreased. The details of these saponifying processes are described in, for example, Japanese Patent Application Laid-Open No. 2002-82226 and WO 02/46809.

To improve the adhesion of the unstretched or stretched cellulose acylate film to each functional layer, it is preferable to provide an undercoat layer on the cellulose acylate film. The undercoat layer may be provided after carrying out the above described surface treatment or without the surface treatment. The details of the undercoat layers are described in Journal of Technical Disclosure (Laid-Open No. 2001-1745, issued on Mar. 15, 2001, by Japan Institute of Invention and Innovation), 32.

These surface-treatment step and under-coat step can be incorporated into the final part of the film forming step, or they can be performed independently, or they can be performed in the functional-layer providing process described later.

### (2) Providing Functional Layer

Preferably, the stretched and unstretched cellulose acylate films of the present invention are combined with any one of the functional layers described in detail in Journal of Technical Disclosure (Laid-Open No. 2001-1745, issued on Mar. 15, 2001, by Japan Institute of Invention and Innovation), 32-45. Particularly preferable is providing a polarizing layer (polarizer), optical compensation layer (optical compensation film), antireflection layer (antireflection film) or hard coat layer.

### (I) Providing Polarizing Layer (Preparation of Polarizer)

### (I-1) Materials Used for Polarizing Layer

At the present time, generally, commercially available polarizing layers are prepared by immersing stretched polymer in a solution of iodine or a dichroic dye in a bath so that the iodine or dichroic dye penetrates into the binder. Coating-type of polarizing films, represented by those manufactured by Optiva Inc., are also available as a polarizing film. Iodine or a dichroic dye in the polarizing film develops polarizing properties when its molecules are oriented in a binder. Examples of dichroic dyes applicable include: azo dye, stilbene dye, pyrazolone dye, triphenylmethane dye, quinoline dye, oxazine dye, thiazine dye and anthraquinone dye. The dichroic dye used is preferably water-soluble. The dichroic dye used preferably has a hydrophilic substitute (e.g. sulfo, amino, or hydroxyl). Example of such dichroic dyes includes: compounds described in Journal of Technical Disclosure, Laid-Open No. 2001-1745, 58, (issued on Mar. 15, 2001, by Japan Institute of Invention and Innovation).

Any polymer which is crosslinkable in itself or which is crosslinkable in the presence of a crosslinking agent can be used as a binder for polarizing films. And more than one combination thereof can also be used as a binder. Examples of binders applicable include: compounds described in Japanese Patent Application Laid-Open No. 8-338913, column [0022], such as methacrylate copolymers, styrene copolymers, polyolefin, polyvinyl alcohol and denatured polyvinyl alcohol, poly(N-methylolacrylamide), polyester, polyimide, vinyl acetate copolymer, carboxymethylcellulose, and polycarbonate. Silane coupling agents can also be used as a polymer. Preferable are water-soluble polymers (e.g. poly(N-methylolacrylamide), carboxymethylcellulose, gelatin, polyvinyl alcohol and denatured polyvinyl alcohol), more preferable are gelatin, polyvinyl alcohol and denatured polyvinyl alcohol, and most preferable are polyvinyl alcohol and denatured polyvinyl alcohol. Use of two kinds of polyvinyl alcohol or denatured polyvinyl alcohol having different polymerization degrees in combination is particularly preferable. The saponification degree of polyvinyl alcohol is preferably 70 to 100% and more preferably 80 to 100%. The polymerization degree of polyvinyl alcohol is preferably 100 to 5000. Details of denatured polyvinyl alcohol are described in Japanese Patent Application Laid-Open Nos. 8-338913, 9-152509 and 9-316127. For polyvinyl alcohol and denatured polyvinyl alcohol, two or more kinds may be used in combination.

Preferably, the minimum of the binder thickness is 10 μm. For the maximum of the binder thickness, from the viewpoint of light leakage of liquid crystal displays, preferably the binder has the smallest possible thickness. The thickness of the binder is preferably equal to or smaller than that of currently commercially available polarizer (about 30 μm), more preferably 25 μm or smaller, and much more preferably 20 μm or smaller.

The binder for polarizing films may be crosslinked. Polymer or monomer that has a crosslinkable functional group may be mixed into the binder. Or a crosslinkable functional group may be provided to the binder polymer itself. Crosslinking reaction is allowed to progress by means of light, heat or pH changes, and a binder having a crosslinked structure can be formed by crosslinking reaction. Examples of crosslinking agents applicable are described in U.S. Pat. (Reissued) No. 23297. Boron compounds (e.g. boric acid and borax) may also be used as a crosslinking agent. The amount of the crosslinking agent added to the binder is preferably 0.1 to 20% by mass of the binder. This allows polarizing devices to have good orientation characteristics and polarizing films to have good damp heat resistance.

The amount of the unreacted crosslinking agent after completion of the crosslinking reaction is preferably 1.0% by mass or less and more preferably 0.5% by mass or less. Restraining the unreacted crosslinking agent to such an amount improves the weatherability of the binder.

### (I-2) Stretching Of Polarizing Film

Preferably, a polarizing film is dyed with iodine or a dichroic dye after undergoing stretching (stretching process) or rubbing (rubbing process).

In the stretching process, preferably the stretching magnification is 2.5 to 30.0 and more preferably 3.0 to 10.0. Stretching can be dry stretching, which is performed in the air. Stretching can also be wet stretching, which is performed while immersing a film in water. The stretching magnification in the dry stretching is preferably 2.5 to 5.0, while the stretching magnification in the wet stretching is preferably 3.0 to 10.0. Stretching may be performed parallel to the MD direction (parallel stretching) or in an oblique (oblique stretching). These stretching operations may be performed at one time or in several installments. Stretching can be performed more uniformly even in high-ratio stretching if it is performed in several installments.

(a) Parallel Stretching Method

Prior to stretching, a PVA film is swelled. The degree of swelling is 1.2 to 2.0 (ratio of mass before swelling to mass after swelling). After this swelling operation, the PVA film is stretched in a water-based solvent bath or in a dye bath in which a dichroic substance is dissolved at a bath temperature of 15 to 50° C., preferably 17 to 40° C. while continuously conveying the film via a guide roll etc. Stretching can be accomplished in such a manner as to grip the PVA film with 2 pairs of nip rolls and control the conveying speed of nip rolls so that the conveying speed of the latter pair of nip rolls is higher than that of the former pair of nip rolls. The stretching magnification is based on the length of PVA film after stretching/the length of the same in the initial state ratio (hereinafter the same), and from the viewpoint of the above described advantages, the stretching magnification is preferably 1.2 to 3.5 and more preferably 1.5 to 3.0. After this stretching operation, the film is dried at 50° C. to 90° C. to obtain a polarizing film.

(b) Oblique Stretching Method

Oblique stretching can be performed by the method described in Japanese Patent Application Laid-Open No. 2002-86554 in which a tenter that projects on a tilt is used. This stretching is performed in the air; therefore, it is necessary to allow a film to contain water so that the film is easy to stretch. Preferably, the water content in the film is 5% or higher and 100% or lower, the stretching temperature is 40° C. or higher and 90° C. or lower, and the humidity during the stretching operation is preferably 50% rh or higher and 100% rh or lower.

In stretching, the temperature is preferably 40° C. or higher and 90° C. or lower and more preferably 50° C. or higher and 80° C. or lower, the humidity is preferably 50% rh or more and 100% rh or less, more preferably 70% rh or more and 100% rh or less, and furthermore preferably 80% rh or more and 100% rh or less. The longitudinal traveling speed is preferably 1 m/min or more and more preferably 3 m/min or more. Subsequently to stretching, drying is carried out preferably for 0.5 minute or more and 10 minutes or less and more preferably for 1 minute or more and 5 minutes of less, preferably at 50° C. or higher and 100° C. or lower and more preferably at 60° C. or higher and 90° C. or lower.

The absorbing axis of the polarizing film thus obtained is preferably 10 degrees to 80 degrees, more preferably 30 degrees to 60 degrees, and much more preferably substantially 45 degrees (40 degrees to 50 degrees).

### (I-3) Laminating

The cellulose acylate film having undergone the above described saponification and the polarizing layer prepared by stretching are laminated together to yield a sheet polarizer. The laminating is preferably carried out in such a way that the angle between the flow casting axis direction of the cellulose acylate film and the stretching axis direction of the sheet polarizer is 45 degrees.

Any adhesive can be used for the lamination. Examples of adhesives applicable include: PVA resins (including denatured PVA such as acetoacetyl, sulfonic, carboxyl or oxyalkylen group) and aqueous solutions of boron compounds. Of these adhesives, PVA resins are preferable. The thickness of the adhesive layer is preferably 0.01 to 10 μm and particularly preferably 0.05 to 5 μm, on a dried layer basis.

Preferably, the sheets of polarizer thus obtained have a high light transmittance and a high degree of polarization. The light transmittance of the polarizer is preferably in the range of 30 to 50% at a wavelength of 550 nm, more preferably in the range of 35 to 50%, and most preferably in the range of 40 to 50%. The degree of polarization is preferably in the range of 90 to 100% at a wavelength of 550 nm, more preferably in the range of 95 to 100%, and most preferably in the range of 99 to 100%.

The sheets of polarizer thus obtained can be laminated with a λ/4 plate to create circularly polarized light. In this case, they are laminated so that the angle between the slow axis of the λ/4 plate and the absorbing axis of the polarizer is 45 degrees. Any λ/4 plate can be used to create circularly polarized light; however, preferably one having such wavelength-dependency that retardation is decreased with decrease in wavelength is used. More preferably, a polarizing film having an absorbing axis which tilts 20 degrees to 70 degrees in the longitudinal direction and a λ/4 plate that includes an optically anisotropic layer made up of a liquid crystalline compound are used.

### (II) Optical Compensation Layer (Formation of Optical Compensation Film)

An optically anisotropic layer is used for compensating the liquid crystalline compound in a liquid crystal cell in black display by a liquid crystal display. It is prepared by forming an orientation film on each of the stretched and unstretched cellulose acylate films and providing an optically anisotropic layer on the orientation film.

### (II-1) Orientation Film

An orientation film is provided on the above described stretched and unstretched cellulose acylate films which have undergone surface treatment. This film has the function of specifying the orientation direction of liquid crystalline molecules. However, this film is not necessarily indispensable constituent of the present invention. This is because a liquid crystalline compound plays the role of the orientation film, as long as the aligned state of the liquid crystalline compound is fixed after it undergoes orientation treatment. In other words, the sheets of polarizer of the present invention can also be prepared by transferring only the optically anisotropic layer on the orientation film, where the orientation state is fixed, on the polarizer. An orientation film can be provided using a technique such as rubbing of an organic compound (preferably polymer), oblique deposition of an inorganic compound, formation of a micro-groove-including layer, or built-up of an organic compound (e.g. ω-tricosanic acid, dioctadecyl methyl ammonium chloride, methyl stearate) by Langmur-Blodgett technique (LB membrane). Orientation films in which orientation function is produced by the application of electric field, electromagnetic field or light irradiation are also known.

Preferably, the orientation film is formed by rubbing of polymer. As a general rule, the polymer used for the orientation film has a molecular structure having the function of aligning liquid crystalline molecules.

In the present invention, preferably the orientation film has not only the function of aligning liquid crystalline molecules, but also the function of combining a side chain having a crosslinkable functional group (e.g. double bond) with the main chain or the function of introducing a crosslinkable functional group having the function of aligning liquid crystalline molecules into a side chain.

Either polymer which is crosslinkable in itself or polymer which is crosslinkable in the presence of a crosslinking agent can be used for the orientation film. And a plurality of the combinations thereof can also be used. Examples of such polymer include: those described in Japanese Patent Application Laid-Open No. 8-338913, column [0022], such as methacrylate copolymers, styrene copolymers, polyolefin, polyvinyl alcohol and denatured polyvinyl alcohol, poly(N-methylolacrylamide), polyester, polyimide, vinyl acetate copolymer, carboxymethylcellulose, and polycarbonate. Silane coupling agents can also be used as a polymer. Preferable are water-soluble polymers (e.g. poly(N-methylolacrylamide), carboxymethylcellulose, gelatin, polyvinyl alcohol and denatured polyvinyl alcohol), more preferable are gelatin, polyvinyl alcohol and denatured polyvinyl alcohol, and most preferable are polyvinyl alcohol and denatured polyvinyl alcohol. Use of two kinds of polyvinyl alcohol or denatured polyvinyl alcohol having different polymerization degrees in combination is particularly preferable. The saponification degree of polyvinyl alcohol is preferably 70 to 100% and more preferably 80 to 100%. The polymerization degree of polyvinyl alcohol is preferably 100 to 5000.

Side chains having the function of aligning liquid crystal molecules generally have a hydrophobic group as a functional group. The kind of the functional group is determined depending on the kind of liquid crystalline molecules and the aligned state required. For example, a denatured group of denatured polyvinyl alcohol can be introduced by copolymerization denaturation, chain transfer denaturation or block polymerization denaturation. Examples of denatured groups include: hydrophilic groups (e.g. carboxylic, sulfonic, phosphonic, amino, ammonium, amide and thiol groups); hydrocarbon groups with 10 to 100 carbon atoms; fluorine-substituted hydrocarbon groups; thioether groups; polymerizable groups (e.g. unsaturated polymerizable groups, epoxy group, azirinyl group); and alkoxysilyl groups (e.g. trialkoxy, dialkoxy, monoalkoxy). Specific examples of these denatured polyvinyl alcohol compounds include: those described in Japanese Patent Application Laid-Open No. 2000-155216, columns [0022] to [0145], Japanese Patent Application Laid-Open No. 2002-62426, columns [0018] to [0022].

Combining a side chain having a crosslinkable functional group with the main chain of the polymer of an orientation film or introducing a crosslinkable functional group into a side chain having the function of aligning liquid crystal molecules makes it possible to copolymerize the polymer of the orientation film and the polyfunctional monomer contained in the optically anisotropic layer. As a result, not only the molecules of the polyfunctional monomer, but also the molecules of the polymer of the orientation film and those of the polyfunctional monomer and the polymer of the orientation film are covalently firmly bonded together. Thus, introduction of a crosslinkable functional group into the polymer of an orientation film enables remarkable improvement in the strength of optical compensation films.

The crosslinkable functional group of the polymer of the orientation film preferably has a polymerizable group, like the polyfunctional monomer. Specific examples of such crosslinkable functional groups include: those described in Japanese Patent Application Laid-Open No. 2000-155216, columns [0080] to [0100]. The polymer of the orientation film can be crosslinked using a crosslinking agent, besides the above described crosslinkable functional groups.

Examples of crosslinking agents applicable include: aldehyde; N-methylol compounds; dioxane derivatives; compounds that function by the activation of their carboxyl group; activated vinyl compounds; activated halogen compounds; isoxazol; and dialdehyde starch. Two or more kinds of crosslinking agents may be used in combination. Specific examples of such crosslinking agents include: compounds described in Japanese Patent Application Laid-Open No. 2002-62426, columns [0023] to [0024]. Aldehyde, which is highly reactive, particularly glutaraldehyde is preferably used as a crosslinking agent.

The amount of the crosslinking agent added is preferably 0.1 to 20% by mass of the polymer and more preferably 0.5 to 15% by mass. The amount of the unreacted crosslinking agent remaining in the orientation film is preferably 1.0% by mass or less and more preferably 0.5% by mass or less. Controlling the amount of the crosslinking agent and unreacted crosslinking agent in the above described manner makes it possible to obtain a sufficiently durable orientation film, in which reticulation does not occur even after it is used in a liquid crystal display for a long time or it is left in an atmosphere of high temperature and high humidity for a long time.

Basically, an orientation film can be formed by: coating the above described polymer, as a material for forming an orientation film, on a transparent substrate containing a crosslinking agent; heat drying (crosslinking) the polymer; and rubbing the same. The crosslinking reaction may be carried out at any time after the polymer is applied to the transparent substrate, as described above. When a water-soluble polymer, such as polyvinyl alcohol, is used as the material for forming an orientation film, the coating solution is preferably a mixed solvent of an organic solvent having an anti-foaming function (e.g. methanol) and water. The mixing ratio is preferably such that water:methanol=0:100 to 99:1 and more preferably 0:100 to 91:9. The use of such a mixed solvent suppresses the generation of foam, thereby significantly decreasing defects not only in the orientation film, but also on the surface of the optically anisotropic layer.

As a coating method for coating an orientation film, spin coating, dip coating, curtain coating, extrusion coating, rod coating or roll coating is preferably used. Particularly preferably used is rod coating. The thickness of the film after drying is preferably 0.1 to 10 μm. The heat drying can be carried out at 20° C. to 110° C. To achieve sufficient crosslinking, preferably the heat drying is carried out at 60° C. to 100° C. and particularly preferably at 80° C. to 100° C. The drying time can be 1 minute to 36 hours, but preferably it is 1 minute to 30 minutes. Preferably, the pH of the coating solution is set to a value optimal to the crosslinking agent used. When glutaraldehyde is used, the pH is 4.5 to 5.5 and particularly preferably 5.0.

The orientation film is provided on the stretched and unstretched cellulose acylate films or on the above described undercoat layer. The orientation film can be obtained by crosslinking the polymer layer and providing rubbing treatment on the surface of the polymer layer, as described above.

The above described rubbing treatment can be carried out using a treatment method widely used in the treatment of liquid crystal orientation in LCD. Specifically, orientation can be obtained by rubbing the surface of the orientation film in a fixed direction with paper, gauze, felt, rubber or nylon, polyester fiber and the like. Generally the treatment is carried out by repeating rubbing a several times using a cloth in which fibers of uniform length and diameter have been uniformly transplanted.

In the rubbing treatment industrially carried out, rubbing is performed by bringing a rotating rubbing roll into contact with a running film including a polarizing layer. The circularity, cylindricity and deviation (eccentricity) of the rubbing roll are preferably 30 μm or less respectively. The wrap angle of the film wrapping around the rubbing roll is preferably 0.1 to 90°. However, as described in Japanese Patent Application Laid-Open No. 8-160430, if the film is wrapped around the rubbing roll at 360° or more, stable rubbing treatment is ensured. The conveying speed of the film is preferably 1 to 100 m/min. Preferably, the rubbing angle is properly selected from the range of 0 to 60°. When the orientation film is used in liquid crystal displays, the rubbing angle is preferably 40° to 50° and particularly preferably 45°.

The thickness of the orientation film thus obtained is preferably in the range of 0.1 to 10 μm.

Then, liquid crystalline molecules of the optically anisotropic layer are aligned on the orientation film. After that, if necessary, the polymer of the orientation film and the polyfunctional monomer contained in the optically anisotropic layer are reacted, or the polymer of the orientation film is crosslinked using a crosslinking agent.

The liquid crystalline molecules used for the optically anisotropic layer include: rod-shaped liquid crystalline molecules and discotic liquid crystalline molecules. The rod-shaped liquid crystalline molecules and discotic liquid crystalline molecules may be either high-molecular-weight liquid crystalline molecules or low-molecular-weight liquid crystalline molecules, and they include low-molecule liquid crystalline molecules which have undergone crosslinking and do not show liquid crystallinity any more.

### (II-2) Rod-Shaped Liquid Crystalline Molecules

Examples of rod-shaped liquid crystalline molecules preferably used include: azomethines, azoxys, cyanobiphenyls, cyanophenyl esters, benzoate esters, cyclohexane carboxylic acid phenyl esters, cyanophenyl cyclohexanes, cyano-substituted phenyl pyrimidines, alkoxy-substituted phenyl pyrimidines, phenyl dioxanes, tolans, and alkenyl cyclohexyl benzonitriles.

Rod-shaped liquid crystalline molecules also include metal complexes. Liquid crystal polymer that includes rod-shaped liquid crystalline molecules in its repeating unit can also be used as rod-shaped liquid crystalline molecules. In other words, rod-shaped liquid crystalline molecules may be bonded to (liquid crystal) polymer.

Rod-shaped liquid crystalline molecules are described in Kikan Kagaku Sosetsu (Survey of Chemistry, Quarterly), Vol. 22, Chemistry of Liquid Crystal (1994), edited by The Chemical Society of Japan, Chapters 4, 7 and 11 and in Handbook of Liquid Crystal Devices, edited by 142th Committee of Japan Society for the Promotion of Science, Chapter 3.

The index of birefringence of the rod-shaped liquid crystalline molecules is preferably in the range of 0.001 to 0.7. To allow the aligned state to be fixed, preferably the rod-shaped liquid crystalline molecules have a polymerizable group. As such a polymerizable group, a radically polymerizable unsaturated group or cationically polymerizable group is preferable. Specific examples of such polymerizable groups include: polymerizable groups and polymerizable liquid crystal compounds described in Japanese Patent Application Laid-Open No. 2002-62427, columns [0064] to [0086].

### (II-3) Discotic Liquid Crystalline Molecules

Discotic liquid crystalline molecules include: benzene derivatives described in the research report by C. Destrade et al., Mol. Cryst. Vol. 71, 111 (1981); truxene derivatives described in the research report by C. Destrade et al., Mol. Cryst. Vol. 122, 141 (1985) and Physics lett, A, Vol. 78, 82 (1990); cyclohexane derivatives described in the research report by B. Kohne et al., Angew. Chem. Vol. 96, 70 (1984); and azacrown or phenylacetylene macrocycles described in the research report by J. M. Lehn et al., J. Chem. Commun., 1794 (1985) and in the research report by J. Zhang et al., L. Am. Chem. Soc. Vol. 116, 2655 (1994).

Discotic liquid crystalline molecules also include liquid crystalline compounds having a structure in which straight-chain alkyl group, alkoxy group and substituted benzoyloxy group are substituted radially as the side chains of the mother nucleus at the center of the molecules. Preferably, the compounds are such that their molecules or groups of molecules have rotational symmetry and they can provide an optically anisotropic layer with a fixed orientation. In the ultimate state of the optically anisotropic layer formed of discotic liquid crystalline molecules, the compounds contained in the optically anisotropic layer are not necessarily discotic liquid crystalline molecules. The ultimate state of the optically anisotropic layer also contain compounds such that they are originally of low-molecular-weight discotic liquid crystalline molecules having a group reactive with heat or light, but undergo polymerization or crosslinking by heat or light, thereby becoming higher-molecular-weight molecules and losing their liquid crystallinity. Examples of preferred discotic liquid crystalline molecules are described in Japanese Patent Application Laid-Open No. 8-50206. And the details of the polymerization of discotic liquid crystalline molecules are described in Japanese Patent Application Laid-Open No. 8-27284.

To fix the discotic liquid crystalline molecules by polymerization, it is necessary to bond a polymerizable group, as a substitute, to the discotic core of the discotic liquid crystalline molecules. Compounds in which their discotic core and a polymerizable group are bonded to each other via a linking group are preferably used. With such compounds, the aligned state is maintained during the polymerization reaction. Examples of such compounds include: those described in Japanese Patent Application Laid-Open No. 2000-155216, columns [0151] to [0168].

In hybrid orientation, the angle between the long axis (disc plane) of the discotic liquid crystalline molecules and the plane of the polarizing film increases or decreases, across the depth of the optically anisotropic layer, with increase in the distance from the plane of the polarizing film. Preferably, the angle decreases with increase in the distance. The possible changes in angle include: continuous increase, continuous decrease, intermittent increase, intermittent decrease, change including both continuous increase and continuous decrease, and intermittent change including increase and decrease. The intermittent changes include the area midway across the thickness where the tilt angle does not change. Even if the change includes the area where the angle does not change, it does not matter as long as the angle increases or decreased as a whole. Preferably, the angle changes continuously.

Generally, the average direction of the long axis of the discotic liquid crystalline molecules on the polarizing film side can be adjusted by selecting the type of discotic liquid crystalline molecules or the material for the orientation film, or by selecting the method of rubbing treatment. On the other hand, generally the direction of the long axis (disc plane) of the discotic liquid crystalline molecules on the surface side (on the air side) can be adjusted by selecting the type of discotic liquid crystalline molecules or the type of the additives used together with the discotic liquid crystalline molecules. Examples of additives used with the discotic liquid crystalline molecules include: plasticizer, surfactant, polymerizable monomer, and polymer. The degree of the change in orientation in the long axis direction can also be adjusted by selecting the type of the liquid crystalline molecules and that of additives, like the above described cases.

### (II-4) Other Compositions of Optically Anisotropic Layer

Use of plasticizer, surfactant, polymerizable monomer, etc. together with the above described liquid crystalline molecules makes it possible to improve the uniformity of the coating film, the strength of the film and the orientation of liquid crystalline molecules. Preferably, such additives are compatible with the liquid crystalline molecules, and they can change the tilt angle of the liquid crystalline molecules or do not inhibit the orientation of the liquid crystalline molecules.

Examples of polymerizable monomers applicable include radically polymerizable or cationically polymerizable compounds. Preferable are radically polymerizable polyfunctional monomers which are copolymerizable with the above described polymerizable-group containing liquid crystalline compounds. Specific examples are those described in Japanese Patent Application Laid-Open No. 2002-296423, columns [0018] to [0020]. The amount of the above described compounds added is generally in the range of 1 to 50% by mass of the discotic liquid crystalline molecules and preferably in the range of 5 to 30% by mass.

Examples of surfactants include traditionally known compounds; however, fluorine compounds are particularly preferable. Specific examples of fluorine compounds include compounds described in Japanese Patent Application Laid-Open No. 2001-330725, columns [0028] to [0056].

Preferably, polymers used together with the discotic liquid crystalline molecules can change the tilt angle of the discotic liquid crystalline molecules.

Examples of polymers applicable include cellulose esters. Examples of preferred cellulose esters include those described in Japanese Patent Application Laid-Open No. 2000-155216, columns [0178]. Not to inhibit the orientation of the liquid crystalline molecules, the amount of the above described polymers added is preferably in the range of 0.1 to 10% by mass of the liquid crystalline molecules and more preferably in the range of 0.1 to 8% by mass.

The discotic nematic liquid crystal phase-solid phase transition temperature of the discotic liquid crystalline molecules is preferably 70 to 300° C. and more preferably 70 to 170° C.

### (II-5) Preparation of Optically Anisotropic Layer

An optically anisotropic layer can be formed by coating the surface of the orientation film with a coating fluid that contains liquid crystalline molecules and, if necessary, polymerization initiator or any other ingredients described later.

As a solvent used for preparing the coating fluid, an organic solvent is preferably used. Examples of organic solvents applicable include: amides (e.g. N,N-dimethylformamide); sulfoxides (e.g. dimethylsulfoxide); heterocycle compounds (e.g. pyridine); hydrocarbons (e.g. benzene, hexane); alkyl halides (e.g. chloroform, dichloromethane, tetrachloroethane); esters (e.g. methyl acetate, butyl acetate); ketones (e.g. acetone, methyl ethyl ketone); and ethers (e.g. tetrahydrofuran, 1,2-dimethoxyethane). Alkyl halides and ketones are preferably used. Two or more kinds of organic solvent can be used in combination.

Such a coating fluid can be applied by a known method (e.g. wire bar coating, extrusion coating, direct gravure coating, reverse gravure coating or die coating method).

The thickness of the optically anisotropic layer is preferably 0.1 to 20 μm, more preferably 0.5 to 15 μm, and most preferably 1 to 10 μm.

### (II-6) Fixation of Orientation State of Liquid Crystalline Molecules

The aligned state of the aligned liquid crystalline molecules can be maintained and fixed. Preferably, the fixation is performed by polymerization. Types of polymerization include: heat polymerization using a heat polymerization initiator and photopolymerization using a photopolymerization initiator. For the fixation, photopolymerization is preferably used.

Examples of photopolymerization initiators include: α-carbonyl compounds (described in U.S. Pat. Nos. 2,367,661 and 2,367,670); acyloin ethers (described in U.S. Pat. No. 2,448,828); α-hydrocarbon-substituted aromatic acyloin compounds (U.S. Pat. No. 2,722,512); multi-nucleus quinone compounds (described in U.S. Pat. Nos. 3,046,127 and 2,951,758); combinations of triarylimidazole dimmer and p-aminophenyl ketone (described in U.S. Pat. No. 3,549,367); acridine and phenazine compounds (described in Japanese Patent Application Laid-Open No. 60-105667 and U.S. Pat. No. 4,239,850); and oxadiazole compounds (described in U.S. Pat. No. 4,212,970).

The amount of the photopolymerization initiators used is preferably in the range of 0.01 to 20% by mass of the solid content of the coating fluid and more preferably in the range of 0.5 to 5% by mass.

Light irradiation for the polymerization of liquid crystalline molecules is preferably performed using ultraviolet light.

Irradiation energy is preferably in the range of 20 mJ/cm2 to 50 J/cm2, more preferably 20 to 5000 mJ/cm2, and much more preferably 100 to 800 mJ/cm2. To accelerate the photopolymerization, light irradiation may be performed under heat.

A protective layer may be provided on the surface of the optically anisotropic layer.

Combining the optical compensation film with a polarizing layer is also preferable. Specifically, an optically anisotropic layer is formed on a polarizing film by coating the surface of the polarizing film with the above described coating fluid for an optically anisotropic layer. As a result, thin polarlizer, in which stress generated with the dimensional change of polarizing film (distorsion×cross-sectional area×modulus of elasticity) is small, can be prepared without using a polymer film between the polarizing film and the optically anisotropic layer. Installing the polarizer according to the present invention in a large-sized liquid crystal display device enables high-quality images to be displayed without causing problems such as light leakage.

Preferably, stretching is performed while keeping the tilt angle of the polarizing layer and the optical compensation layer to the angle between the transmission axis of the two sheets of polarizer laminated on both sides of a liquid crystal cell constituting LCD and the longitudinal or transverse direction of the liquid crystal cell. Generally the tilt angle is 45°. However, in recent years, transmissive-, reflective-, and semi-transmissive-liquid crystal display devices have been developed in which the tilt angle is not always 45°, and thus, it is preferable to adjust the stretching direction arbitrarily to the design of each LCD.

### (II-7) Liquid Crystal Display Devices

Liquid crystal modes in which the above described optical compensation film is used will be described.

### <TN-Mode Liquid Crystal Display Devices>

TN-mode liquid crystal display devices are most commonly used as a color TFT liquid crystal display device and described in a large number of documents. The aligned state in a TN-mode liquid crystal cell in the black state is such that the rod-shaped liquid crystalline molecules stand in the middle of the cell while the rod-shaped liquid crystalline molecules lie near the substrates of the cell.

### <OCB-Mode Liquid Crystal Display Devices>

An OCB-mode liquid crystal cell is a bend orientation mode liquid crystal cell where the rod-shaped liquid crystalline molecules in the upper part of the liquid cell and those in the lower part of the liquid cell are aligned in substantially opposite directions (symmetrically). Liquid crystal displays using a bend orientation mode liquid crystal cell are disclosed in U.S. Pat. Nos. 4,583,825 and 5,410,422. A bend orientation mode liquid crystal cell has a self-compensation function since the rod-shaped liquid crystalline molecules in the upper part of the liquid cell and those in the lower part are symmetrically aligned. Thus, this liquid crystal mode is also referred to as OCB (Optically Compensatory Bend) liquid crystal mode.

Like in the TN-mode cell, the aligned state in an OCB-mode liquid crystal cell in the black state is also such that the rod-shaped liquid crystalline molecules stand in the middle of the cell while the rod-shaped liquid crystalline molecules lie near the substrates of the cell.

### <VA-Mode Liquid Crystal Display Devices>

VA-mode liquid crystal cells are characterized in that in the cells, rod-shaped liquid crystalline molecules are aligned substantially vertically when no voltage is applied. The VA-mode liquid crystal cells include: (1) a VA-mode liquid crystal cell in a narrow sense where rod-shaped liquid crystalline molecules are aligned substantially vertically when no voltage is applied, while they are aligned substantially horizontally when a voltage is applied (Japanese Patent Application Laid-Open No. 2-176625); (2) a MVA-mode liquid crystal cell obtained by introducing multi-domain switching of liquid crystal into a VA-mode liquid crystal cell to obtain wider viewing angle, (SID 97, Digest of Tech. Papers (Proceedings) 28 (1997) 845), (3) a n-ASM-mode liquid crystal cell where rod-shaped liquid crystalline molecules undergo substantially vertical orientation when no voltage is applied, while they undergo twisted multi-domain orientation when a voltage is applied (Proceedings 58 to 59 (1998), Symposium, Japanese Liquid Crystal Society); and (4) a SURVAIVAL-mode liquid crystal cell (reported in LCD international 98).

### <IPS-Mode Liquid Crystal Display Devices>

IPS-mode liquid crystal cells are characterized in that in the cells, rod-shaped liquid crystalline molecules are aligned substantially horizontally in plane when no voltage is applied and switching is performed by changing the orientation direction of the crystal in accordance with the presence or absence of application of voltage. Specific examples of IPS-mode liquid crystal cells applicable include those described in Japanese Patent Application Laid-Open Nos. 2004-365941, 2004-12731, 2004-215620, 2002-221726, 2002-55341 and 2003-195333.

### <Other Modes of Liquid Crystal Display Devices>

In ECB-mode, STN (Supper Twisted Nematic)-mode, optical compensation can also be achieved with the above described logic.

### (III) Providing Antireflection Layer (Antireflection Film)

Generally an antireflection film is made up of: a low-refractive-index layer which also functions as a stainproof layer; and at least one layer having a refractive index higher than that of the low-refractive-index layer (i.e. high-refractive-index layer and/or intermediate-refractive-index layer) provided on a transparent substrate.

Methods of forming a multi-layer thin film as a laminate of transparent thin films of inorganic compounds (e.g. metal oxides) having different refractive indices include: chemical vapor deposition (CVD); physical vapor deposition (PVD); and a method in which a film of a colloid of metal oxide particles is formed by sol-gel process from a metal compound such as a metal alkoxide and the formed film is subjected to post-treatment (ultraviolet light irradiation: Japanese Patent Application Laid-Open No. 9-157855, plasma treatment: Japanese Patent Application Laid-Open No. 2002-327310).

On the other hand, there are proposed a various antireflection films, as highly productive antireflection films, which are formed by coating thin films of a matrix and inorganic particles dispersing therein in a laminated manner.

There is also provided an antireflection film including an antireflection layer provided with anti-glare properties, which is formed by using an antireflection film formed by coating as described above and providing the outermost surface of the film with fine irregularities.

The cellulose acylate film of the present invention is applicable to antireflection films formed by any of the above described methods, but particularly preferable is the antireflection film formed by coating (coating type antireflection film).

### (III-1) Layer Configuration of Coating-Type Antireflection Film

An antireflection film having at least on its substrate a layer construction of: intermediate-refractive-index layer, high-refractive-index layer and low-refractive-index layer (outermost layer) in this order is designed to have a refractive index satisfying the following relationship.

Refractive index of high-refractive-index layer>refractive index of intermediate-refractive-index layer>refractive index of transparent substrate>refractive index of low-refractive-index layer, and a hard coat layer may be provided between the transparent substrate and the intermediate-refractive-index layer.

The antireflection film may also be made up of: intermediate-refractive-index hard coat layer, high-refractive-index layer and low-refractive-index layer.

Examples of such antireflection films include: those described in Japanese Patent Application Laid-Open Nos. 8-122504, 8-110401, 10-300902, 2002-243906 and 2000-111706. Other functions may also be imparted to each layer. There are proposed, for example, antireflection films that include a stainproofing low-refractive-index layer or anti-static high-refractive-index layer (e.g. Japanese Patent Application Laid-Open Nos. 10-206603 and 2002-243906).

The haze of the antireflection film is preferably 5% or less and more preferably 3% or less. The strength of the film is preferably H or higher, by pencil hardness test in accordance with JIS K5400, more preferably 2H or higher, and most preferably 3H or higher.

### (III-2) High-Refractive-Index Layer and Intermediate-Refractive-Index Layer

The layer of the antireflection film having a high refractive index consists of a curable film that contains: at least ultra-fine particles of high-refractive-index inorganic compound having an average particle size of 100 nm or less; and a matrix binder.

Fine particles of high-refractive-index inorganic compound include: for example, those of inorganic compounds having a refractive index of 1.65 or more and preferably 1.9 or more. Specific examples of such inorganic compounds include: oxides of Ti, Zn, Sb, Sn, Zr, Ce, Ta, La or In; and composite oxides containing these metal atoms.

Methods of forming such ultra-fine particles include: for example, treating the particle surface with a surface treatment agent (e.g. a silane coupling agent, Japanese Patent Application Laid-Open Nos. 11-295503, 11-153703, 2000-9908, an anionic compound or organic metal coupling agent, Japanese Patent Application Laid-Open No. 2001-310432 etc.); allowing particles to have a core-shell structure in which a core is made up of high-refractive-index particle(s) (Japanese Patent Application Laid-Open No. 2001-166104 etc.); and using a specific dispersant together (Japanese Patent Application Laid-Open No. 11-153703, U.S. Pat. No. 6,210,858B1, Japanese Patent Application Laid-Open No. 2002-2776069, etc.).

Materials used for forming a matrix include: for example, conventionally known thermoplastic resins and curable resin films.

Further, as such a material, at least one composition is preferable which is selected from the group consisting of: a composition including a polyfunctional compound that has at least two radically polymerizable and/or cationically polymerizable group; an organic metal compound containing a hydrolytic group; and a composition as a partially condensed product of the above organic metal compound. Examples of such materials include: compounds described in Japanese Patent Application Laid-Open Nos. 2000-47004, 2001-315242, 2001-31871 and 2001-296401.

A curable film prepared using a colloidal metal oxide obtained from the hydrolyzed condensate of metal alkoxide and a metal alkoxide composition is also preferred. Examples are described in Japanese Patent Application Laid-Open No. 2001-293818.

The refractive index of the high-refractive-index layer is generally 1.70 to 2.20. The thickness of the high-refractive-index layer is preferably 5 nm to 10 μm and more preferably 10 nm to 1 μm.

The refractive index of the intermediate-refractive-index layer is adjusted to a value between the refractive index of the low-refractive-index layer and that of the high-refractive-index layer. The refractive index of the intermediate-refractive-index layer is preferably 1.50 to 1.70.

### (III-3) Low-Refractive-Index Layer

The low-refractive-index layer is formed on the high-refractive-index layer sequentially in the laminated manner. The refractive index of the low-refractive-index layer is 1.20 to 1.55 and preferably 1.30 to 1.50.

Preferably, the low-refractive-index layer is formed as the outermost layer having scratch resistance and stainproofing properties. As means of significantly improving scratch resistance, it is effective to provide the surface of the layer with slip properties, and conventionally known thin film forming means that includes introducing silicone or fluorine is used.

The refractive index of the fluorine-containing compound is preferably 1.35 to 1.50 and more preferably 1.36 to 1.47. The fluorine-containing compound is preferably a compound that includes a crosslinkable or polymerizable functional group containing fluorine atom in an amount of 35 to 80% by mass.

Examples of such compounds include: compounds described in Japanese Patent Application Laid-Open No. 9-222503, columns [0018] to [0026], Japanese Patent Application Laid-Open No. 11-38202, columns [0019] to [0030], Japanese Patent Application Laid-Open No. 2001-40284, columns [0027] to [0028], Japanese Patent Application Laid-Open No. 2000-284102, etc.

A silicone compound is preferably such that it has a polysiloxane structure, it includes a curable or polymerizable functional group in its polymer chain, and it has a crosslinking structure in the film. Examples of such silicone compounds include: reactive silicone (e.g. SILAPLANE manufactured by Chisso Corporation); and polysiloxane having a silanol group on each of its ends (one described in Japanese Patent Application Laid-Open No. 11-258403).

The crosslinking or polymerization reaction for preparing such fluorine-containing polymer and/or siloxane polymer containing a crosslinkable or polymerizable group is preferably carried out by radiation of light or by heating simultaneously with or after applying a coating composition for forming an outermost layer, which contains a polymerization initiator, a sensitizing agent, etc.

A sol-gel cured film is also preferable which is obtained by curing the above coating composition by the condensation reaction carried out between an organic metal compound, such as silane coupling agent, and silane coupling agent containing a specific fluorine-containing hydrocarbon group in the presence of a catalyst.

Examples of such films include: those of polyfluoroalkyl-group-containing silane compounds or the partially hydrolyzed and condensed compounds thereof (compounds described in Japanese Patent Application Laid-Open Nos. 58-142958, 58-147483, 58-147484, 9-157582 and 11-106704); and silyl compounds that contain “perfluoroalkyl ether” group as a fluoline-containing long-chain group (compounds described in Japanese Patent Application Laid-Open Nos. 2000-117902, 2001-48590 and 2002-53804).

The low-refractive-index layer can contain additives other than the above described ones, such as filler (e.g. low-refractive-index inorganic compounds whose primary particles have an average particle size of 1 to 150 nm, such as silicon dioxide (silica) and fluorine-containing particles (magnesium fluoride, calcium fluoride, barium fluoride); organic fine particles described in Japanese Patent Application Laid-Open No. 11-3820, columns [0020] to [0038]), silane coupling agent, slippering agent and surfactant.

When the low refractive index layer is located as an outermost layer, the low-refractive-index layer may be formed by vapor phase method (vacuum evaporation, spattering, ion plating, plasma CVD, etc.). From the viewpoint of reducing manufacturing costs, coating method is preferable.

The thickness of the low-refractive-index layer is preferably 30 to 200 nm, more preferably 50 to 150 nm, and most preferably 60 to 120 nm.

### (III-4) Hard Coat Layer

A hard coat layer is formed on the surface of a transparent support to provide physical strength to anti-reflective film, and particularly formed between the transparent support and the high refractive-index layer.

Preferably, the hard coat layer is formed by the crosslinking reaction or polymerization of compounds curable by light and/or heat. Preferred curable functional groups are photopolymerizable functional groups, and organic metal compounds having a hydrolytic functional group are preferably organic alkoxy silyl compounds.

Specific examples of such compounds include the same compounds as illustrated in the description of the high-refractive-index layer.

Specific examples of compositions that constitute the hard coat layer include: those described in Japanese Patent Application Laid-Open Nos. 2002-144913, 2000-9908 and WO 0/46617.

The hard coat layer can also serves as an anti-glare layer (described later), if particles having an average particle size of 0.2 to 10 μm are added to provide the layer with the anti-glare function.

The thickness of the hard coat layer can be properly designed depending on the applications for which it is used. The thickness of the hard coat layer is preferably 0.2 to 10 μm and more preferably 0.5 to 7 μm.

The strength of the hard coat layer is preferably H or higher, by pencil hardness test in accordance with JIS K5400, more preferably 2H or higher, and much more preferably 3H or higher. The hard coat layer having a smaller abrasion loss in test, before and after Taber abrasion test conducted in accordance with JIS K5400, is more preferable.

### (III-5) Forward Scattering Layer

A forward scattering layer is provided so that it provides, when applied to liquid crystal displays, the effect of improving viewing angle when the angle of vision is tilted up-, down-, right- or leftward. The above described hard coat layer can also serve as a forward scattering layer, if fine particles with different refractive index are dispersed in it.

Example of such layers include: those described in Japanese Patent Application Laid-Open No. 11-38208 where the coefficient of forward scattering is specified; those described in Japanese Patent Application Laid-Open No. 2000-199809 where the relative refractive index of transparent resin and fine particles are allowed to fall in the specified range; and those described in Japanese Patent Application Laid-Open No. 2002-107512 wherein the haze value is specified to 40% or higher.

### (III-6) Other Layers

Besides the above described layers, a primer layer, anti-static layer, undercoat layer or protective layer may be provided.

### (III-7) Coating Method

The layers of the antireflection film can be formed by any method of dip coating, air knife coating, curtain coating, roller coating, wire bar coating, gravure coating, microgravure coating and extrusion coating (U.S. Pat. No. 2,681,294).

### (III-8) Anti-Glare Function

The antireflection film may have the anti-glare function that scatters external light. The anti-glare function can be obtained by forming irregularities on the surface of the antireflection film. When the antireflection film has the anti-glare function, the haze of the antireflection film is preferably 3 to 30%, more preferably 5 to 20%, and most preferably 7 to 20%.

As a method for forming irregularities on the surface of antireflection film, any method can be employed, as long as it can maintain the surface geometry of the film. Such methods include: for example, a method in which fine particles are used in the low-refractive-index layer to form irregularities on the surface of the film (e.g. Japanese Patent Application Laid-Open No. 2000-271878); a method in which a small amount (0.1 to 50% by mass) of particles having a relatively large size (0.05 to 2 μm in particle size) are added to the layer under a low-refractive-index layer (high-refractive-index layer, intermediate-refractive-index layer or hard coat layer) to form a film having irregularities on the surface and a low-refractive-index layer is formed on the irregular surface while keeping the geometry (e.g. Japanese Patent Application Laid-Open Nos. 2000-281410, 2000-95893, 2001-100004, 2001-281407); a method in which irregularities are physically transferred on the surface of the outermost layer (stainproofing layer) having been provided (e.g. embossing described in Japanese Patent Application Laid-Open Nos. 63-278839, 11-183710, 2000-275401).

In the following the measurement methods used in the present invention will be described.

[1] Methods for Measuring Re and Rth

A sample film is conditioned in humidity at a temperature of 25° C. and a humidity of 60% rh for at least 3 hours. Then, with an automatic birefringence meter (Kobra-21ADH/PR manufactured by Oji Scientific Instruments Co., Ltd.), the retardation value of the sample film at a wavelength of 550 nm is measured at 25° C. and 60% rh, in a direction normal to the surface of the sample film and in a direction inclined by ±40° from the normal of the film surface. The in-plane retardation (Re) is derived from the measured value for the normal direction, and the thickness direction retardation (Rth) is derived from the measured values in the normal direction and the direction inclined by 40° from the normal of the film surface.

[2] Re, Rth, and Transverse and Longitudinal Fluctuations of Re and Rth

### (1) MD Direction Sampling

In the longitudinal direction of the film, 1-cm-side squares are cut out at 100 positions with an interval of 0.5 m.

### (2) TD Direction Sampling

Along the whole width of the film, 1-cm-side squares are cut out at 50 positions with an even interval.

### (3) Measurement of Re and Rth

A sample film is conditioned in humidity at a temperature of 25° C. and a humidity of 60% rh for at least 3 hours. Then, with an automatic birefringence meter (Kobra-21ADH/PR manufactured by Oji Scientific Instruments Co., Ltd.), the retardation value of the sample film at a wavelength of 550 nm is measured at 25° C. and 60% rh, in a direction normal to the surface of the sample film and in a direction inclined by ±40° from the normal of the film surface. The in-plane retardation (Re) is derived from the measured value for the normal direction, and the thickness direction retardation (Rth) is derived from the measured values in the normal direction and the direction inclined by +40° from the normal of the film surface.

Each of Re and Rth is defined as the average value over all the above described sampling positions concerned.

### (4) Fluctuations of Re and Rth

The fluctuation of Re is derived by dividing the difference between the maximum and minimum values of all of the 100 sampling position values associated with the MD direction by the average value of these 100 values and by presenting the thus obtained quotient in terms of percents; and the fluctuation of Rth is derived in the same manner as above except that the 50 sampling position values associated with the TD direction are used in place of the 100 sampling position values associated with the MD direction.

[3] Evaluation of Streak

The appearance of the cellulose acylate film obtained is visually observed. A sample having no streak is indicated by “G”; a sample having minor streak but no practical problem by “NG”; a sample having minor streak and a practical problem by “B”; and a sample having apparent streak by “P”.

[4] Substitution Degrees in Cellulose Acylate

The substitution degrees of the acyl groups in the cellulose acylate are obtained through ¹³C-NMR according to the method described in Carbohydr. Res., 273 (1955) 83-91 (Tezuka, et al.).

[5] Peak Heat Amount in DSC Crystal Melting

A DSC apparatus, DSC-50, manufactured by Shimadzu Seisakusho is used; measurement is made at a temperature increasing rate of 10° C./min; the heat amount of the heat absorption peak to occur immediately after Tg is derived in units of J/g, and Tg is also measured at the same time.

[6] Haze Value

The haze value is measured with a turbidity meter NDH-1001DP manufactured by Nippon Denshoku Kogyo Co., Ltd. is used.

[7] Yellowness Index (YI Value)

The yellowness (YI: yellowness index) is measured with Z-II OPTICAL SENSOR according to JIS K7105 6.3.

A reflection method is applied to pellets and a transmission method is applied to films; the tristimulus values X, Y and Z are measured; the YI value is derived from the tristimulus values X, Y and Z on the basis of the following formula:

YI={(1.28X−1.06Z)/Y}1×100

Each of the YI values for films derived from the above formula is divided by the film thickness to be converted into a value per 1 mm; these converted values are used for comparison.

[8] Molecular Weight

Film samples are dissolved in dichloromethane and the molecular weights are measured with GPC.

### EXAMPLES

### <Cellulose Acylate Resin>

The cellulose acylates different from each other in the types and the substitution degrees of the acyl groups described in the tables of FIGS. 5A and 5B were prepared. In the preparation, acylation reaction was carried out at 40° C. with sulfuric acid added as catalyst (7.8 parts by weight in relation to 100 parts by weight of the cellulose) and carboxylic acids added to be raw material of the acyl substituents; the types and the substitution degrees of the acyl groups were controlled by controlling the types and the amounts of the carboxylic acids; and on completion of the acylation, aging was carried out at 40° C. The Tg values of the cellulose acylates thus obtained were measured by means of the following method and listed in the tables of FIGS. 5A and 5B.

### <Measurement of Tg>

On the measuring pan of a DSC apparatus, 20 mg of a sample was placed. In a gas flow of nitrogen, the sample was heated from 30° C. to 250° C. at a rate of 10° C./min (the first run), and then, cooled down to 30° C. at a rate of −10° C./min. Thereafter, the sample was again heated from 30° C. to 250° C. (the second run). The glass transition temperature (Tg) was defined as the temperature at which the base line started to deviate on the lower temperature side in the second run. The Tg values listed in the tables of FIGS. 5A and 5B are based on this definition. To every sample, 0.05% by mass of silicon dioxide fine particles (Aerosil R972V) was added.

### <Melt Film Formation>

Each synthesized cellulose acylate shown in the tables of FIGS. 5A and 5B was blast-dried at 120° C. for 3 hours so that its water content was 0.1% by mass. To the dried cellulose acylate were added 3% by weight of triphenyl phosphate (TPP) as a plasticizer, 0.05% by mass of silicon dioxide fine particles (AEROZIL R-972V), 0.20% by mass of phosphite-based stabilizer (P-1), 0.8% by mass of “ultraviolet absorber a”, 2,4-bis-(n-octylthio)-6-(4-hydroxy-3,5-di-tert-butylanilino)-1,3,5-triazine, and 0.25% by mass of “ultraviolet absorber b”, 2(2′-hydroxy-3′,5′-di-tert-butylphenyl)-5-chlorobenzotriazole. The mixture was melt-kneaded at 190° C. with twin-screw kneading extruder. The twin-screw kneading extruder was provided with a vacuum vent to perform vacuum evacuation (set to 0.3 atm). The kneaded cellulose acylate was extruded in a water bath into a strand 3 mm in diameter and cut to 5 mm.

The kneaded resin obtained above was dried by air (for dehumidification) at 90° C. for 3 hours. After the moisture content was reduced to 0.1 wt %, the resin was melted at 210° C. by a single screw extruder in which a full-flight screw (L/D=35, compression rate 3.5, screw diameter: 65 mm) was inserted. The molten resin was fed in a constant amount by a gear pump in order to improve dimensional accuracy of thickness of the resultant film. The quantified molten polymer was sent from the gear pump, passed through a sintered filter of 4 μm (in mesh size) to remove foreign matter and fed to a die having a slit. The molten resin was cooled and solidified while being sandwiched between a press roller (DR1) and a pressurizing/cooling roller (CR1). The solidified sheet was further cooled and solidified by the cooling roller (CR2), removed from the roller and rolled up into a roll. Each of the pressurizing/cooling roller (CR1) and cooling roller used herein (CR2) had a surface roughness and diameter shown in the tables of FIGS. 5A and 5B. As the press roller (DR1), an elastic roller was used. The surface roughness, diameter and outer cylinder wall thickness of the press roller are shown in the tables of FIGS. 5A and 5B. The temperatures of these rollers are also shown in the tables of FIGS. 5A and 5B. Other conditions of the pressurizing/cooling roller (CR1) and press roller (DR1) including contact length Q, line pressure P, film-forming speed, sheet length between the rollers, sheet temperature, sheet shrinkage rate are shown in the tables of FIGS. 5A and 5B. Note that both edges (each corresponding to 3% of the entire width) of a film were trimmed immediately before rolling up. Thereafter, knurling (10 mm in width, 50 μm in height) was provided to both edges. Each film was rolled up into a roll (1.5 m in width, 3000 m in length) at a rate of 30 n/minute. Note that the overall evaluation of the tables of FIGS. 5A and 5B was based on the following criteria.

B: The film has visible defects in the appearance and problems in practical use.

NG: The film has visible defects in the appearance but no problems in practical use.

G: The film has no defects

E. The film has no defects and excellent smoothness without small wave and wrinkle.

As is apparent from tables of FIGS. 5A and 5B, the appearance of the film is substantially good in Examples 1 to 12 where the temperature of the cooling roller (CR2) is set at within the range of +3° C. relative to the sheet temperature in contact with the cooling roller (CR2) and the temperature of the sheet removed from the cooling roller (CR2) arranged most downstream of a plurality of cooling rollers is set to be equal and less than a glass transition temperature Tg(° C.) of a thermoplastic resin −15° C. In contrast, a wrinkled and loosen film are observed in Comparative Examples 2 to 7 where the temperature of the cooling roller is not set to be equal and less than +3° C. relative to the sheet temperature in contact with the cooling roller.

Among Examples 1 to 12, Example 8 in which zero shear viscosity of the thermoplastic resin extruded from the die does not satisfy the condition of 2000 Pa·sec or less are compared to Examples 1 to 7 in which the zero shear viscosity satisfies the condition, overall evaluation is low. Provided that the difference between the glass transition temperature Tg(° C.) of the thermoplastic resin and the temperature of the elastic roller (DR1) is represented by X(° C.), and a line speed is represented by Y (n/min), in Examples 9 to 12, X and Y satisfy the relationship:

0.0043X²+0.12X+1.1<Y<0.019X²+0.73X+24.

Provided that the length of the region of the sheet via which the pressurizing/cooling roller (CR1) and press roller (DR1) are in contact with each other, is represented by Q (cm) and a line pressure of these rollers applied on the sheet sandwiched between them is represented by P (kg/cm), in Examples 9 to 12, P and Q do not satisfy the relationship:

3 kg/cm²<P/Q<50 kg/cm².

Overall evaluations of Examples 9 to 12 are low compared to those of Examples 1 to 7.

### <Preparation of Polarizer>

### 1. Preparation of Polarizer

### (1) Surface Treatment

The thermoplastic resin films listed in tables of FIGS. 5A and 5B were saponificated by the soaking method mentioned below. Although saponification by coating was also performed, the same results as in the soaking method were obtained.

(i) Soaking Saponification

A 1.5N aqueous solution of NaOH was used as a saponifying solution. The solution was controlled in temperature to be set at 60° C., and a cellulose acylate film was soaked therein for 2 minutes. Thereafter, the film was soaked in a 0.1 N aqueous solution of sulfuric acid for 30 seconds, and then passed through a water washing bath.

(ii) Coating Saponification

To 80 parts by weight of iso-propanol, 20 parts by weight of water was added, and KOH was dissolved therein so as to become 1.5 N. The solution was controlled in temperature to be set at 60° C., which solution was used as a saponifying solution. The saponifying solution was coated on a cellulose acylate film set at 60° C. in a coating amount of 10 g/m² to saponify the film for 1 minute. On completion of the saponification, the film was washed by spraying warm water set at 50° C. onto the film for 1 minute by use of a spray at a flow rate of 10 L/m²·min.

### (2) Preparation of Polarizing Layer

According to Example 1 of Japanese Patent Laid-Open No. 2001-141926, a film was stretched in the longitudinal direction by applying a difference in peripheral speed between two pairs of niprolls to prepare a 20 μm thick polarizing layer. The stretched polarizing layers were also prepared for which the stretching axis direction was inclined by 45 degrees similarly to Example 1 of Japanese Patent Laid-Open No. 2002-86554, and the results of the below described evaluation of these polarizing layers were the same as those of the above described polarizing layers.

### (3) Lamination

The polarizing layer thus obtained was adhered to the thermoplastic resin film formed, stretched and saponificated as mentioned above to form a polarizer. More specifically, polarizers having the structures mentioned below were formed by laminating a polarizing layer and a thermoplastic resin film with an adhesive agent, a 3% aqueous PVA (PVA-117H manufactured by Kraray. Co., Ltd.). Note that Fujitack (TD80 manufactured by Fuji Photo Film Co., Ltd.) described below was also saponificated in the same manner as mentioned above.

Polarizer A: Stretched thermoplastic resin film/polarizing layer/Fujitack

Polarizer B: Stretched thermoplastic resin film/polarizing layer/unstretched thermoplastic resin film

(In polarizer B, the stretched and unstretched thermoplastic resin films were formed of the same type of thermoplastic resin).

A untreated polarizer thus obtained, a wet-thermo polarizer treated in a wet thermo process (60° C., a relative humidity of 90%, 500 hours), and a dry-thermo polarizer treated in a dry thermo process (80° C., dry air, 500 hours) were installed in a 20 inch VA type liquid crystal display device as shown in FIGS. 2 to 9 of Japanese Patent Application Laid-Open No. 2000-154261 such that the stretched cellulose acylate is placed at the liquid crystal side. These liquid crystal devices using the untreated polarizer, dry-thermo polarizer, and wet-thermo polarizer were visually compared for color irregularity. The color irregularity was judged based on a ratio of the region whose color changed occupied in the whole area. Good performance was obtained.

### 2. Preparation of Optical Compensation Film

An optical compensation film was formed by use of the thermoplastic resin film according to the present invention in place of a cellulose acetate film having a liquid crystal layer (according to Example 1 of Japanese Patent Application Laid-Open No. 11-316378) formed thereon by coating. An optical compensation film obtained immediately after stretching, a wet-thermo optical compensation film treated in a wet thermo process (60° C., a relative humidity of 90%, 500 hours), and a dry-thermo optical compensation film treated in a dry thermo process (80° C., dry air, 500 hours) were visually evaluated for color irregularity. The optical compensation film using the thermoplastic resin film according to the present invention had good performance.

An optical compensation filter film was formed by using the thermoplastic resin film according to the present invention in place of the cellulose acetate film having the liquid crystal layer according to Example 1 of Japanese Patent Application Laid-Open No. 7-333433 formed by a coating method. Also in this case, a good optical compensation film was formed.

### 3. Preparation of Low Reflective Films

The thermoplastic resin film of the present invention was used to prepare a low reflection film according to Example 47 of Hatsumei Kyokai Kokai Giho (Ko-Gi No. 2001-1745), resulting in excellent optical performances.

### 4. Preparation of Liquid Crystal Display Elements

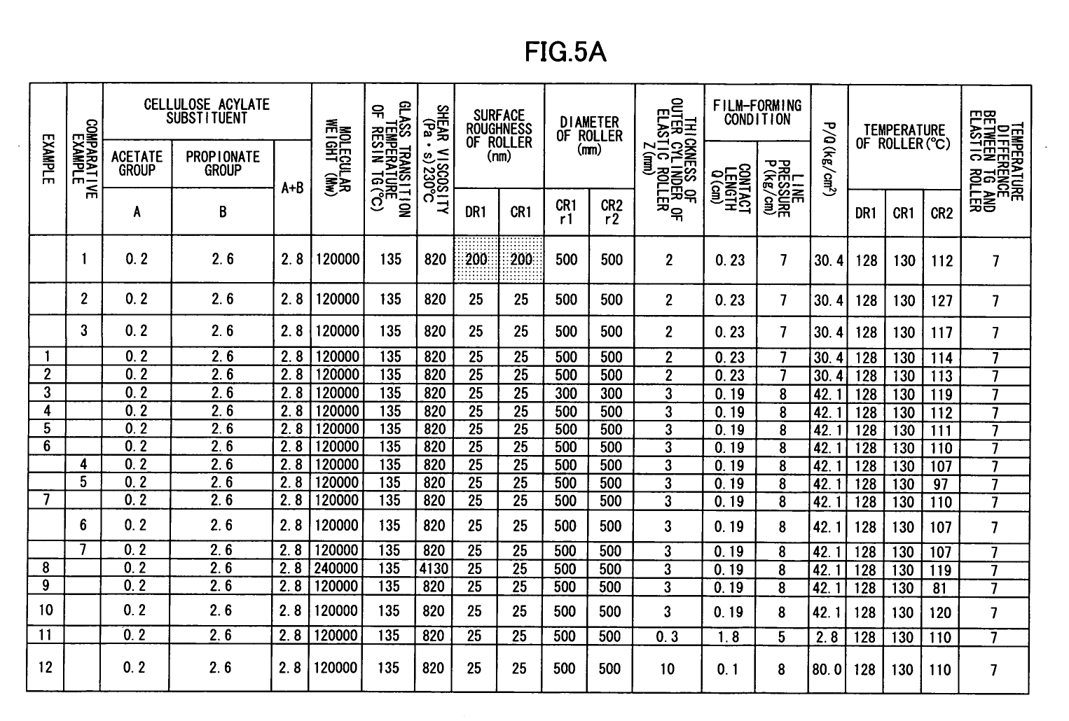

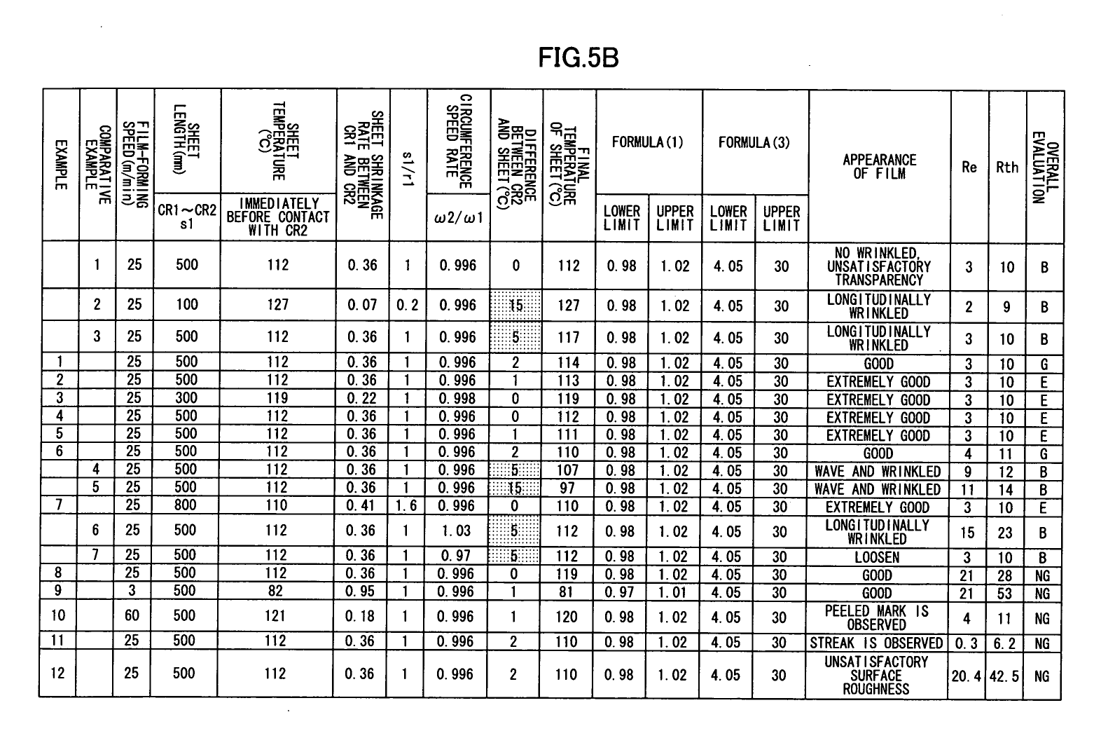

The aforementioned sheet polarizers of the present invention were applied to the liquid crystal display devices described in Example 1 of Japanese Patent Laid-Open No. 10-48420, the optical anisotropy layers containing discotic liquid crystal molecules described and the oriented films coated with polyvinyl alcohol in Example 1 of Japanese Patent Laid-Open No. 9-26572, the 20 inch-VA type liquid crystal display devices described in FIGS. 2 to 9 of Japanese Patent Laid-Open No. 2000-154261, the 20 inch-OCB type liquid crystal display devices described in FIGS. 10 to 15 of Japanese Patent Laid-Open No. 2000-154261, and the IPS type liquid crystal display device described in FIG. 11 of Japanese Patent Laid-Open No. 2004-12731. Further, the low reflection films of the present invention were applied to the outermost layer of these liquid crystal display devices to evaluate the performances thereof. Consequently, satisfactory liquid crystal display elements were able to be obtained.

What is claimed is:

1. A method of manufacturing a thermoplastic resin film comprising the steps of:
extruding a molten thermoplastic resin from a die in a form of sheet;
cooling and solidifying the thermoplastic resin sheet by sandwiching the sheet between a pressurizing/cooling roller and a press roller having a surface roughness Ra of 100 nm or less in terms of an arithmetic average height; and
further cooling and solidifying the thermoplastic resin sheet while transferring the thermoplastic resin sheet by a plurality of cooling rollers, wherein
the temperature of each of the cooling rollers is set at within a range of ±3° C. relative to sheet temperature of the thermoplastic resin sheet in contact with the cooling roller; at the same time, the sheet temperature of the thermoplastic resin sheet when removed from the cooling roller arranged most downstream of the cooling rollers is set to be equal to or less than a glass transition temperature Tg(° C.) of the thermoplastic resin −15° C.

2. The method of manufacturing a thermoplastic resin film according to claim 1, wherein,
in the pressurizing/cooling roller and the cooling rollers, the ratio in circumference speed of rollers arranged adjacent with each other satisfies Equation (1) and the sheet length between adjacent rollers satisfies Equation (2),
0.98×(1−cₙ/100)<[(roller circumference speed ratio)=ωₙ₊₁/ωₙ]<1.02×(1−cₙ/100) (1);
sₙ/rₙ>0.3 (2);
where the diameter of the roller arranged at the n-th position from the upstream side is represented by rₙ (cm), the length of the sheet between the n-th roller and the (n+1)th roller is represented by sₙ (cm), the thermal shrinkage of the sheet between the n-th roller and the (n+1)th roller is represented by cₙ(%), the circumference speed of the n-th roller is represented by ωₙ.

3. The method of manufacturing a thermoplastic resin film according to claim 1, wherein at least one of the pressurizing/cooling roller and the press roller is an elastic roller made of a metal.

4. The method of manufacturing a thermoplastic resin film according to claim 2, wherein at least one of the pressurizing/cooling roller and the press roller is an elastic roller made of a metal.

5. The method of manufacturing a thermoplastic resin film according to claim 3, wherein the pressurizing/cooling roller and the press roller satisfy any one of Equations (3), (4), and (5) below:
0.0043X²+0.12X+1.1<Y<0.019X²+0.73X+24 (3),
where the difference between the glass transition temperature Tg(° C.) of the thermoplastic resin and the temperature of the elastic roller is represented by X(° C.), and a line speed is represented by Y (m/min);
0.05 mm<Z<7.0 mm (4),
where Z is a wall thickness of an outer cylinder of the elastic roller;
3 kg/cm²<P/Q<50 kg/cm² (5),
where the length of the region at which the pressurizing/cooling roller and the press roller are in contact with each other via the thermoplastic resin sheet, is represented by Q (cm), and a line pressure applied by the pressurizing/cooling roller and the press roller sandwiching the thermoplastic resin sheet is represented by P (kg/cm).

6. The method of manufacturing a thermoplastic resin film according to claim 1, wherein
the plurality of cooling rollers have a surface roughness Ra of 100 nm or less in terms of an arithmetic average height.

7. The method of manufacturing a thermoplastic resin film according to claim 2, wherein
the plurality of cooling rollers have a surface roughness Ra of 100 nm or less in terms of an arithmetic average height.

8. The method of manufacturing a thermoplastic resin film according to claim 3, wherein
the plurality of cooling rollers have a surface roughness Ra of 100 nm or less in terms of an arithmetic average height.

9. The method of manufacturing a thermoplastic resin film according to claim 5, wherein
the plurality of cooling rollers have a surface roughness Ra of 100 nm or less in terms of an arithmetic average height.

10. The method of manufacturing a thermoplastic resin film according to claim 1, wherein
a zero shear viscosity of the thermoplastic resin extruded from the die is 2000 Pa·sec or less.

11. The method of manufacturing a thermoplastic resin film according to claim 2, wherein
a zero shear viscosity of the thermoplastic resin extruded from the die is 2000 Pa·sec or less.

12. The method of manufacturing a thermoplastic resin film according to claim 3, wherein
a zero shear viscosity of the thermoplastic resin extruded from the die is 2000 Pa·sec or less.

13. The method of manufacturing a thermoplastic resin film according to claim 5, wherein
a zero shear viscosity of the thermoplastic resin extruded from the die is 2000 Pa·sec or less.

14. The method of manufacturing a thermoplastic resin film according to claim 6, wherein
a zero shear viscosity of the thermoplastic resin extruded from the die is 2000 Pa·sec or less.

15. The method of manufacturing a thermoplastic resin film according to claim 1, wherein
a thickness of the film is 20 to 300 μm, in-plane retardation Re is 20 nm or less and retardation Rth in a thickness direction is 20 nm or less.

16. The method of manufacturing a thermoplastic resin film according to claim 2, wherein
a thickness of the film is 20 to 300 μm, in-plane retardation Re is 20 nm or less and retardation Rth in a thickness direction is 20 nm or less.

17. The method of manufacturing a thermoplastic resin film according to claim 3, wherein
a thickness of the film is 20 to 300 μm, in-plane retardation Re is 20 nm or less and retardation Rth in a thickness direction is 20 nm or less.

18. The method of manufacturing a thermoplastic resin film according to claim 5, wherein
a thickness of the film is 20 to 300 μm, in-plane retardation Re is 20 nm or less and retardation Rth in a thickness direction is 20 nm or less.

19. The method of manufacturing a thermoplastic resin film according to claim 6, wherein
a thickness of the film is 20 to 300 μm, in-plane retardation Re is 20 nm or less and retardation Rth in a thickness direction is 20 nm or less.

20. The method of manufacturing a thermoplastic resin film according to claim 10, wherein
a thickness of the film is 20 to 300 μm, in-plane retardation Re is 20 nm or less and retardation Rth in a thickness direction is 20 nm or less.

21. A thermoplastic resin film manufactured by the method according to claim 1.

22. A thermoplastic resin film manufactured by the method according to claim 2.

23. A thermoplastic resin film manufactured by the method according to claim 3.

24. A thermoplastic resin film manufactured by the method according to claim 5.

25. A thermoplastic resin film manufactured by the method according to claim 6.

26. A thermoplastic resin film manufactured by the method according to claim 10.

27. A thermoplastic resin film manufactured by the method according to claim 15.

28. The thermoplastic resin film according to claim 21, wherein
the thermoplastic resin is a cellulose acylate resin.

29. The thermoplastic resin film according to claim 28, wherein
the cellulose acylate resin has a number average molecular weight of 20,000 to 80,000, and provided that degree of substitution with an acetyl group is represented by A and the sum of degrees of substitution with acyl groups having 3 to 7 carbon atoms is represented by B, A and B satisfy:
2.0≦A+B≦3.0,
0≦A≦2.0,
1.2≦B≦2.9.

30. An optical compensation film for use in a liquid crystal display board wherein
the optical compensation film has a substrate formed of the thermoplastic resin film according to claim 21.

31. A polarizer comprising at least one of the thermoplastic resin film according to claim 21 as a protecting film.
